(19) United States
(12) Patent Application Publication
(10) Pub. No.: US 2022/0076216 A1
(43) Pub. Date: Mar. 10, 2022

(54) TELECOMMUNICATION SYSTEMS AND METHODS FOR BROKER-MEDIATED PAYMENT

(71) Applicant: Charles T. FOTE, Cherry Hills, CO (US)

(72) Inventor: Charles T. FOTE, Cherry Hills, CO (US)

(21) Appl. No.: 17/530,533

(22) Filed: Nov. 19, 2021

Related U.S. Application Data
(63) Continuation of application No. 15/094,456, filed on Apr. 8, 2016, now abandoned.
Application No. 15/094,456 is a continuation-in-part of application No. 14/455,526, filed on Aug. 8, 2014.
Application No. 14/455,526 is a continuation of application No. 14/048,428, filed on Oct. 8, 2013, now abandoned.

(51) Int. Cl. G06Q 20/02; G06Q 20/40; G06Q 20/32

(52) U.S. Cl. CPC G06Q 20/02; G06Q 20/3227; G06Q 20/40

(57) ABSTRACT

In certain embodiments of systems and methods for conducting payment transactions between a payer and a payee, the payer selects one or more payment sources from various funding sources and accounts available to the payer, and instructs a payment broker's server to perform payment authorization and/or payment making, causing to be made, routing and/or clearing services on the payer's behalf. The payment broker's server notifies the payer and/or the payee of the payment authorization status and, if approved, instructs the funding source's server to cause the payment to be made to payer-selected or approved real account(s) of the payee, or otherwise to the payee, without divulging the payer-selected funding source(s) and payer-selected real account(s) of the payer to the payee's depository bank or financial institution and/or to the payee.

### CROSS-REFERENCE TO RELATED APPLICATIONS

This application is a continuation-in-part of and claims priority to U.S. Ser. No. 14/455,526 (filed on Aug. 8, 2014) which is a continuation of and claims priority to U.S. Ser. No. 14/048,428 (filed on Oct. 8, 2013). The foregoing applications are incorporated herein by reference in their entireties.

### FIELD OF THE INVENTION

The invention generally relates to systems and methods for payer-controlled payment transactions where a payer wishes to cause a payment to be made to or for the benefit of a payee.

### BACKGROUND OF THE INVENTION

Today's payment systems and methods are dominated by legacy systems based on cash, checks, debit or credit cards, and transfers among user accounts. These legacy concepts are manifest in typical point of sale (“POS”) and electronic payment environments. Payment transactions handled by these legacy systems can relate to the payment for goods or services purchased by the payer (whether in traditional POS transactions or otherwise) or to other types of payments made by the payer.

Despite the advances in the supporting technology, the primary model for payment transactions has not changed substantially. For instance, the main relationships in the current purchasing/payment model using checks or credit or debit cards or accounts are between (a) a merchant and an acquiring financial institution, and (b) a purchaser and an issuing financial institution. The financial institutions are at the center of this business model and they control the current technological environments found in most payment situations. Therefore, the payee and the payer ordinarily are forced to accept and use the financial institutions' systems and methods, which may be opposed to the needs or desires of the payee and the payment wishes of the payer.

Legacy systems and methods were not designed to deal with transactions that occur over public computer and telecommunication networks and involve the exchange of data that can be intercepted by malicious actors. Nonetheless, many legacy systems and methodologies persist and have been adapted to operate over modern communication architectures, rather than being re-designed from scratch. At the same time, technology infrastructures (e.g., computer networks, servers, computer systems, etc.) have evolved to support the growth in payment transactions and now incorporate additional functionality to improve security and reduce privacy weaknesses in the original implementations. Payment Card Industry Data Security Standard (PCI DSS) is an example of after-the-fact rules and processes that attempt to patch the security and privacy weaknesses in legacy payment systems. To accommodate these new security and privacy rules and policies, existing servers and computer network infrastructures must oftentimes undergo extensive, often massive, change.

Modifying and patching these legacy systems is costly, often inefficient and to an extent ineffective as additional security and privacy weaknesses can arise as a result of changing existing payment processing servers and networks. In addition, the restrictions of existing payment systems do not necessarily promote the development or growth of new payment services, payment types or payment devices. Further, the financial institutions that own and operate the existing payment systems can be resistant to changes in those systems or related revenue models, and thus can impede innovation rather than promote it.

The advent of mobile commerce places still further stress on legacy systems that were designed for closed operation without significant risk of data interception. Individuals engaging in financial transactions using electronic or mobile devices have privacy as well as security concerns, although these concerns obviously overlap. For example, a payer may wish to make a payment without divulging the identity of his or her funding source or real account.

Theoretically, the payer could contract with a third party to make a payment to a payer-designated payee on the payer's behalf by, for example, issuing its own paper check payable to the payee, thereby shielding the identity of the payer's funding source and real account. The inconvenience of such an arrangement, particularly in today's era of electronic commerce when many payments need to be made electronically over telecommunication systems or computer networks, would be considerable.

In addition, electronically conducted payment transactions have novel vulnerabilities without precedent or analogy in traditional commerce. For example, in “man in the middle” attacks, the attacker secretly relays and may alter the communication between two parties who believe they are directly communicating with each other—for example, a payer and the payer's funding source. This allows the attacker to divert the transaction for his own benefit or acquire enough information about the payer to spoof the funding source and transfer funds from the payer's account. This problem is particularly acute in the case of electronic payments to payees, because the basic infrastructure of electronic financial transactions is set up for auditability, which favors inclusion of chain-of-transaction details at each step. But those details can reveal the payer's sensitive funding source and real account information.

Another type of attack targets the stored account information and credentials of a merchant whose customers pay electronically or online; a single “hack” into the merchant's computer systems can expose to attack the financial accounts of all of its customers. Financial institutions, too, are not immune from attack. And even inserting a payment broker between the payer and payee may not shield the payer's funding source or real account information from attack: the payment broker is merely one more link in the electronic transaction chain, so the details of all prior links may accompany the electronic payments for audit purposes. Thus, there are serious “network-centric” security and privacy problems specific to electronic payments made over telecommunication systems or computer networks.

Accordingly, there is a need and desire for new payment systems and methods that will address the many security and privacy shortcomings of the current systems and methods without inconveniencing mobile and other electronic payers or impeding the adoption of these increasingly widespread, but vulnerable, technologies.

### BRIEF SUMMARY OF THE INVENTION

In accordance with various embodiments of the invention, payer-controlled payment transactions utilize a mediating broker entity involving one or more servers that the broker entity owns, leases or controls; the broker entity, through its server(s), acts for and at the instruction of the payer to instruct funding source servers to cause payment(s) to be made to payee(s) as described herein, with or without the brokerage server storing identifiers of the real account(s) of the payer from which payment is to be made. In one embodiment, the server of the payment broker authenticates the payer and transmits enough payer-identifying information and an account type to the server of a payer-selected funding source to facilitate the payment transaction, but without actually designating or identifying the payer's real account from which payment is to be made. This approach is distinct from conventional broker-mediated payment systems and methods where the broker either itself serves as the funding source or has the payer's real account information on file, utilizing this information to process and make the payment. In such approaches, the payment broker's storage of or access to the payer's real account information represents an additional security and privacy vulnerability for the payer, providing an additional portal through which malefactors can gain access to the payer's sensitive funding source and real account information.

Various implementations of the invention may include one or more of the following features and advantages:

(a) A payment broker is created whose responsibility it is to implement and use servers that the broker entity owns, leases or controls to instruct the server(s) of payer-selected funding source(s) to cause payment(s) to be made to payee(s) as described herein in accordance with the instruction of the payer with or without storage of, or even access to, the payer's real account information.

(b) As opposed to current conventional systems or methods, the selection of payer funding source(s) and real account(s) or account type(s) to be used for the payment(s), the selection or approval of the depository institution(s) and real account(s) of the payee to which the payment(s) is/are to be caused to be made, as described herein, the initiation and management of the authorization process and the manner in which the payment(s) to the payee is/are to be caused to be made, as described herein, as well as the overall control of the payment process, rests with the payer and not the payee, and are implemented in each case so as to not divulge the payer-selected funding source(s) and payer-selected real account(s) of the payer to the payee's depository bank or financial institution and/or to the payee. In addition, the payer is not restricted to those payment sources or types normally advertised and accepted by a merchant or other payee. Further, the payer can also designate one or more agents or users to act for and as authorized by the payer in communicating with and instructing the payment broker′ server so that payment(s) are caused to be made to payee(s), as described herein, without divulging the payer-selected funding source(s) and payer-selected real account(s) of the payer to the payee's depository bank or financial institution and/or to the payee(s). As but one example, a payer can authorize his or her accountant to act as his or her agent to communicate with and instruct the payment broker's server for or on the payer's behalf in order to cause payment(s) to be made to payee(s), as described herein, from one or more funding source(s) and real account(s) of the payer without divulging the payer-selected funding source(s) and payer-selected real account(s) of the payer to the payee's depository bank or financial institution and/or to the payee.

(c) Once authorization has been obtained and the payer and/or payee so notified, the payment broker can or will guarantee the payment to the payee provided that there are no abnormal circumstances relating to the payment. The notification by the payment broker that authorization has been obtained or denied can be made without divulging the payer-selected funding source(s) and payer-selected real account(s) of the payer to the payee's depository bank or financial institution and/or to the payee.

(d) The payer may select one or more funding sources and real accounts or account types that the payer would like to use for a particular payment. The selection may be or relate to any real account(s) at one or more funding sources which the payer has previously identified to the payment broker by account number or account type and that may result in a transfer of value (e.g., a remittance of funds) from or on behalf of and at the instruction of the payer to the payee upon the completion of the payment without divulging the payer-selected funding source(s) and payer-selected real account(s) of the payer to the payee's depository bank or financial institution and/or to the payee.

(e) Security and privacy modalities can be part of the computer systems, servers, telecommunication systems and network architectures described herein including the use of secure software applications and secure sessions for communications, secure databases, and structuring the computer systems and information interchange to prevent the transmission to payees of accompanying chain-of-transaction details with electronic payments, thereby preventing the divulgation of the payer's sensitive funding source and real account information to the payee's depository bank or financial institution and/or to the payee. In other words, modalities and techniques described herein break the chain of transmission of transaction payment details that accompany an electronic payment and thereby prevent divulgation.

(f) In various implementations, a payee does not have access to or possess any of the payer's funding source or real account information or, in most cases, the method of payment; consequently, the payee's systems (e.g., where the payee is a merchant) do not store such sensitive data, thereby eliminating the risk to the payer or payee of an attack on the payee's systems.

(g) Payees that are merchants can also avoid the capital cost or other expenses relating to modifying their existing POS, server and network systems to accommodate various security and privacy rules (e.g., PCI DSS) determined by funding sources and/or related associations (e.g., VISA, MasterCard, etc.)

(h) Although the payer may have loyalty to one funding source over others, at the time of the payment the payer's loyalty to the payee is reinforced and emphasized regardless of the payer funding source(s) or real account(s) used to cause the payment to be made to the payee. This reinforcement and emphasis can arise in many ways including because the payer now controls the systems and methods described herein thereby resulting in more certainty of payment for the payee and thereby encouraging the payee to provide incentives to the payer (such as discounts, coupons, value-adds, etc.) in consideration of the payer's use of the described systems and methods to effect the payment.

Accordingly, in one aspect, the invention relates to a telecommunication system comprising, in various embodiments, an electronic communication device connected to and configured for communication over a telecommunication network. The electronic device may comprise a device communication facility permitting communication over the telecommunication network via a secure session, and a processor configured for running a secure application for (i) authenticating or obtaining authentication information from a payer, (ii) communicating via secure sessions and accessing secure databases, (iii) receiving payee identifying and real account and financial institution information, (iv) receiving a selection by the payer of a funding source and at least one real account or account type associated with the payer, and (v) receiving a selection by the payer of at least one real account and financial institution associated with the payee. The telecommunication system may further comprise a brokerage server, operated by a payment broker and connected to and configured for communication over the telecommunication network. In various embodiments, the brokerage server comprises a server communication facility permitting communication over the telecommunication network via a secure session; a computer memory comprising a secure database; and a processor configured for (i) receiving authentication information via the telecommunication network using the server communication facility, (ii) authenticating and identifying the payer based on the authentication information, (iii) receiving, via the telecommunication network using the server communication facility, an instruction from the payer instructing that a payment be made electronically from the payer-selected funding source and at least one payer-selected real account or account type thereof to a payer-selected real account and financial institution, other than the payment broker, associated with the payee, the selection of the real account and financial institution associated with the payee being controlled by the payer and not by the payee, (iv) computationally retrieving, from the secure database, information identifying the payer-selected funding source and the at least one payer-selected real account or account type thereof and the payee and the payer-selected real account of the payee at a financial institution other than the payment broker, (v) requesting, via the telecommunication network using the server communication facility, the server of the payer-selected funding source to authorize the payment to the payee, (vi) if the payment is authorized by the server of the payer-selected funding source, instructing such server, via the telecommunication network using the server communication facility, to cause the payment, to be made electronically to the payee on the funding source's behalf by a third party other than the payment broker such that the identities of the payer-selected funding source and the at least one payer-selected real account of the payer at the funding source are not divulged to the payee and such real-account identifying information is not transmitted to, received or stored by the payee's depository bank or other financial institution, and (vii) instructing the server of the payer-selected funding source, via the telecommunication network using the server communication facility, to reimburse or transfer the amount of the payment to the third party from the at least one payer-selected real account of the payer at the funding source. The telecommunication system may further comprise a funding source server, operated by a payer-selected funding source and connected to and configured for communication over the telecommunication network. In various embodiments, the funding source server comprises a server communication facility permitting communication over the telecommunication network via a secure session; a computer memory comprising a secure database; and a processor configured for (i) receiving, via the telecommunication network using the server communication facility, the request from the payment broker server for authorization of the payment (ii) computationally retrieving, from a secure database, information identifying the payer and the at least one payer-selected real account of the payer at the funding source, (iii) authorizing or denying the requested payment, (iv) in response to instruction from the payment broker server following authorization, instructing, via the telecommunication network using the server communication facility, the electronic device of at least one third party other than the payment broker to instruct the server of a bank or financial institution associated with the third party to make the payment electronically to the payee from a real account of the third party at such bank or financial institution and in the third party's name and not in the name of the payment broker, the funding source or the payer; thereby preventing divulgation, both to the payee's depository bank or financial institution and the payee, of the identity of the funding source and the at least one payer-selected real account of the payer, and (v) reimbursing or transferring the amount of the payment to the third party from the at least one payer-selected real account of the payer at the funding source.

In some embodiments, the brokerage server communicates with the payer via a secure session over the telecommunication network using a hand-held payer electronic device. In some embodiments, the brokerage server communicates with the payee via a secure session over the telecommunication network using a payee electronic device.

The instruction from the funding source server to the electronic device of at least one third party other than the payment broker may not, in various embodiments, contain chain-of-transaction payment details containing the payer's funding source or real account information with the electronic payment.

Reference throughout this specification to “one example,” “an example,” “one embodiment,” “an embodiment,” “one implementation,” or “an implementation” means that a particular feature, structure, or characteristic described in connection with the example is included in at least one example of the present invention. Thus, the occurrences of the phrases “in one example,” “in an example,” “one embodiment,” “an embodiment,” “in one implementation” or “an implementation” in various places throughout this specification are not necessarily all referring to the same example. Furthermore, the particular features, structures, routines, steps, or characteristics may be combined in any suitable manner in one or more examples of the present invention. The headings provided herein are for convenience only and are not intended to limit or interpret the scope or meaning of the claimed invention.

### BRIEF DESCRIPTION OF THE DRAWINGS

FIG. 1 depicts a representative architecture and the data flow underlying the operation of a payer/merchant, purchase/payment transaction;

FIG. 2 depicts a transaction flow in accordance with one embodiment of the invention;

FIG. 3 depicts an alternative approach to causing a payment to be made in accordance with one embodiment of the invention;

FIG. 4 depicts a representative architecture and the data flow underlying the operation of a payer/payee payment transaction;

FIG. 5 depicts a transaction flow in accordance with another embodiment of the invention; and

FIG. 6 depicts an alternative approach to causing a payment to be made in accordance with one embodiment of the invention.

### DETAILED DESCRIPTION OF THE INVENTION

### Definitions

For purposes hereof, the following definitions apply regardless of whether a given term is expressed with or without an initial capital letter.

Instruct: In various embodiments of the invention, to “instruct” or to “electronically instruct,” means to communicate to an electronic device (as herein defined), over a computer network, signals or data indicative of an instruction to perform an action.

Network: In various embodiments of the invention, a “network” or a “computer network” refers to any intercommunicating arrangement of electronic devices, including, without limitation, wired or wireless local-area networks (LAN), wide-area networks (WAN), the public telecommunications infrastructure, and/or other types of networks. For example, electronic devices may communicate over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocols. Furthermore, electronic devices may communicate through a combination of wired or wireless networks or paths.

Make a Payment, Occur, Cause a Payment to be Made, or Control: In various embodiments of the invention as further described herein: (i) to “make” a payment is to electronically send, route, clear and deposit the payment in the payee's depository bank or financial institution and real account including through a merchant bank clearing system, an ATM network, an ISO, or any other computer network or telecommunication system including any third-party clearing or routing system, (ii) a payment is “made” or “occurs” when the making of the payment has been accomplished, (iii) a payment is “caused to be made” (or words of similar import) to a payee when, in order to prevent chain-of-transaction details from accompanying the payment to the payee and thereby prevent the divulgation of the payer's sensitive funding source or real account information to the payee's depository bank or financial institution and/or to the payee, (a) the payment broker's server instructs the server of the payer-selected funding source to itself instruct the server of a bank or financial institution with which the funding source has a relationship, such as a bank or financial institution that hosts one or more payment and/or clearing account(s) of the funding source or a bank or financial institution that hosts one or more payment and/or clearing account(s) of the bank or financial institution on behalf of and for the benefits of the funding source, to make the payment to the payer-selected or approved real account of the payee from such payment and/or clearing account(s), (b) the payment broker's server instructs the server of the payer-selected funding source to itself instruct the server of a subsidiary or affiliate of the funding source (which subsidiary or affiliate is itself a bank or financial institution) to make the payment to the payer-selected or approved real account of the payee from a real account(s) of such subsidiary or affiliate at such subsidiary or affiliate, (c) the payment broker's server instructs the server of the payer-selected funding source to itself instruct the electronic device of a subsidiary or affiliate of the funding source (which subsidiary or affiliate is not a bank or financial institution) to instruct the server of a bank or financial institution associated with such subsidiary or affiliate to make the payment from a real account(s) of such subsidiary or affiliate at such bank or financial institution to the payer-selected or approved real account of the payee, or (d) the payment broker's server instructs the server of the payer-selected funding source to itself instruct the electronic device of a third party with which the funding source has an appropriate contractual or other relationship to instruct the server of a bank or other financial institution associated with the third party to make the payment from a real account(s) of the third party at such bank or financial institution to the payer-selected or approved real account of the payee, in each of the foregoing cases so as to not divulge the payer-selected funding source and payer-selected real account(s) of the payer to the payee's depository bank or financial institution and/or to the payee and, concurrently with the server of the payer-selected funding source causing the payment to be made to the payee as described herein at the instruction of the payment broker's server on the payer's behalf in accordance with the payer's instruction as described herein, or after or before the payment is so caused to be made, the payer-selected funding source can use funds from the payer-selected real account(s) of the payer to (I) reimburse the bank or financial institution, subsidiary, affiliate or third party that made or instructed its bank or financial institution make the payment to the payee as described herein, as applicable, for the amount of the payment, (II) pre-fund the amount of the payment to the bank or financial institution, subsidiary, affiliate or third party that will make or instruct its bank or financial institution to make the payment to the payee as described herein, as applicable, or (III) reimburse the funding source, when the funding source has offset the amount of the payment from obligations otherwise owed to the funding source by the bank or financial institution, subsidiary, affiliate or third party that made or instructed its bank or financial institution make the payment to the payee as described herein, as applicable, in each case so as not to divulge the payer-selected funding source and payer-selected real account(s) of the payer to the payee's depository bank or financial institution and/or to the payee, and (iv) to “control” the payment process is meant the exclusive ability to initiate the payment process, select payer funding source(s), real account(s) or account type(s) to be accessed or used for a payment, initiate and manage the authorization process for the payment, determine or approve instructions for causing the payment to be made as described herein, determine or approve routing or clearing instructions for the payment and select or approve the payee depository institution(s) and real account(s) to which the payment is to be caused to be made, as described herein, in each case without divulging the payer-selected funding source(s) and payer-selected real account(s) of the payer to the payee's depository bank or financial institution and/or to the payee. In various embodiments of the invention as described herein, (i) the payer and not the payee, controls the payment process utilizing a payment broker acting on the payer's behalf in accordance with the payer's instructions, and (ii) when a payment is caused to be made to a payee as described herein, the payment can be made without divulging the payer-selected funding source(s) and payer-selected real account(s) of the payer to the payee's depository bank or financial institution and/or to the payee.

Payer: A payer can be any individual or legal entity wishing to cause a payment to be made to a payee. The payer is the person or legal entity that initiates, instructs and controls the systems and methods established and implemented by the payment broker as described in further detail herein. The payer can also designate one or more agents or users to act for and as authorized by the payer in communicating with and instructing the payment broker to cause a payment(s) to be made to payee(s) as described herein, in each case without divulging the payer-selected funding source(s) and the payer-selected real account(s) of the payer to the payee's depository bank or financial institution and/or to the payee(s). Indeed, in a given payment transaction, an individual or entity may be both the payer and the payee.

Payee: A payee can be any individual or legal entity receiving a payment, including without limitation, a merchant. The role of payer or payee is interchangeable based upon the circumstances of the underlying payment transaction, but for every payment transaction there is a payer and a payee.

Payment: Any payment, remittance or transfer of funds for any purpose whatsoever including, without limitation, for the payment of debts, bills or wages; for the purchase of goods or services or for contributions or donations; or any other transfer or conveyance of value whatsoever, including, without limitation, the provision or conveyance of goods or services; or the provision or conveyance of a credit for goods or services; a transfer or license of content, information, software or intellectual property; or any other payment, remittance or transfer of legal tender, funds or value whatsoever, whether now in existence or arising in the future.

Funding Source: A funding source can be a financial institution, credit union, credit card company, phone company, lending organization or any other merchant, service provider, business, legal entity or individual that the payer has a real account with that can be used to cause a payment to be made to a payee as described herein without divulging the payer-selected funding source and payer-selected real account(s) of the payer to the payee's depository bank or financial institution and/or to the payee. In the case of credit cards or accounts, this is the business, legal entity or individual that will extend credit to the payer in order to cause the payment to be made to the payee as described herein without divulging the payer-selected funding source and payer-selected real account(s) of the payer to the payee's depository bank or financial institution and/or to the payee, and assume the credit risk of the credit extension. Other examples of funding sources can include organizations such as PayPal, Apple, Charles Schwab or any business, legal entity or individual where the payer has a real account, and where the server of the funding source will authorize and cause the payment to be made to the payee as described herein at the instruction of the payment broker's server for or on behalf of and in accordance with the instruction of the payer as also described herein, without divulging the payer-selected funding source and payer-selected real account(s) of the payer to the payee's depository bank or financial institution and/or to the payee. The funding source can or will guarantee that the payment will be caused to be made as described herein at the instruction of the payment broker's server for or on behalf of and in accordance with the instruction of the payer as also described herein, in each case without divulging the payer-selected funding source and payer-selected real account(s) of the payer to the payee's depository bank or financial institution and/or to the payee. As discussed herein, a payer may have multiple funding sources. In addition, the payment broker can itself also be a funding source if it hosts one or more real accounts for a payer.

Electronic Devices: These can be typical stationary point of sale terminals found in use today at payee (e.g., merchant) locations. These can also include portable electronic devices such as mobile phones or other devices including, without limitation, PDAs or computer tablets, or any computer, computer system, server or electronic device that is network or Internet-enabled or that can communicate with the payment broker using traditional or wireless telecommunication networks or systems, or other means of electronic or analog communication whether now in existence or arising in the future. An electronic device may also be able to communicate with other electronic devices. As discussed herein, an electronic device may also include an Internet web site or a touch-tone or rotary telephone. It is also important to note that a payer or payee can each register multiple electronic devices with the payment broker with each such device available for the payer's or payee's use, respectively, in instructing or communicating with the payment broker. In addition, each payer or payee can also register one or more electronic devices with the payment broker for use by their respective authorized agents or users in instructing or communicating with the payment broker for and on their behalf. Each of the foregoing electronic devices can be configured to communicate with the payment broker generally or can be configured with restrictions such as limits as to the authorized user(s), funding source(s), depository institution(s) or real account(s) that may be accessed to cause payments to be made to payee(s) as described herein or that may be selected or approved by the payer for where payments to payee(s) are to be caused to be made, without divulging the payer-selected funding source(s) and payer-selected real account(s) of the payer to the payee's depository bank or financial institution and/or to the payee(s). Further, a given electronic device can be a payer electronic device, a payee electronic device or both a payer and a payee electronic device depending upon the payment transaction involved.

Payment Broker: This is a legal entity or organization that establishes, operates and practices the payment broker's servers and methods described herein. The payment broker acts at the instruction of the payer. The payment broker's servers have the ability to process payment instruction(s) from the payer and to ensure that the payee(s) will receive the requested payment(s) from whatever appropriate funding source(s) and real account(s) that the payer chooses for a particular payment(s). The payment broker's servers instruct the server(s) of the payer-selected funding source(s) as to how to cause payment(s) to be made to payee(s) as described herein, in each case without divulging the payer-selected funding source(s) and the payer-selected real account(s) of the payer to the payee's depository bank or financial institution and/or to the payee.

Payment Broker Account Reference Numbers: These are user-controlled identifiers (numbers, names or combinations of numbers, characters or names) that the payer (or in some cases the payee) chooses to represent real accounts (or in the case of the payer, account types) at various funding sources or payment receiving depository institutions.

Real Account(s): A “real account” is a specific user account with an identifier known to the user and the funding source or depository institution, such as a credit card number, debit card number, checking account number, deposit account number, merchant or service provider account number, etc. Examples of real accounts are accounts as now known or as may be developed in the future including accounts that are associated with credit cards or debit cards, and including demand deposit accounts, checking accounts, loyalty accounts, value accounts, savings accounts, credit union accounts or deposit accounts, or credit accounts with merchants or service providers, etc. When the payer sets up a relationship with the payment broker, it can provide the identifiers corresponding to the real account(s) or account type(s) to be used to cause payments to be made or the real account(s) of the payee to receive payments, respectively, as described herein, and it can also choose payment broker account reference number(s) to represent such real account(s) or account type(s) and their identifier(s). Likewise, if a payee sets up a relationship with the payment broker, it may provide the identifiers corresponding to the real account(s) that it requests be used to receive payments, and it may also choose payment broker account reference number(s) to represent such real account(s) and their identifier(s). Accordingly, it may be possible for more than one payment broker account reference number to be assigned to a given real account and its identifiers, provided that each such payment broker account reference number is unique and correctly corresponds to the given real account and its identifiers.

Thus, a payment broker account reference number can be used by a payer or payee as a reference and association to a given real account and related identifiers at a given funding source or depository institution when transacting via the payment broker. Also, a payment broker account reference number can be used by a payer as a reference and association to a given account type at a given funding source when transacting via the payment broker. For example, rather than entering real account identifiers in an electronic device, a payer or payee may send the payment broker their payment broker account reference number that will be used by the payment broker's server to associate it with the payer's or payee's corresponding real account and identifiers at a specific funding source or depository institution for use in a particular payment transaction. In this manner, real account identifiers are not stored on or sent by the electronic device and are less likely to be compromised or captured by hackers or criminals.

One of the main functions of the payment broker can be to make the funding source(s), real account(s) and, in most cases, the methods of payment, selected by the payer opaque to the payee. That is, the payee may not have any visibility into, control over or concern about the funding source(s) or real account(s) selected by the payer or, in most cases, the methods by which the payment(s) is/are caused to be made into the payer-selected or approved real account(s) of the payee. Provided that the requested payment is authorized by the server of the payer-selected funding source and the payee is so notified, the payment broker can or will guarantee the payment to the payee provided that there are no abnormal circumstances relating to the payment. The approval or denial of an authorization request can be sent by the payment broker's server without the payment broker's server divulging the payer-selected funding source(s) and payer-selected real account(s) of the payer to the payee's depository bank or financial institution and/or to the payee.

### Architecture and General Flow

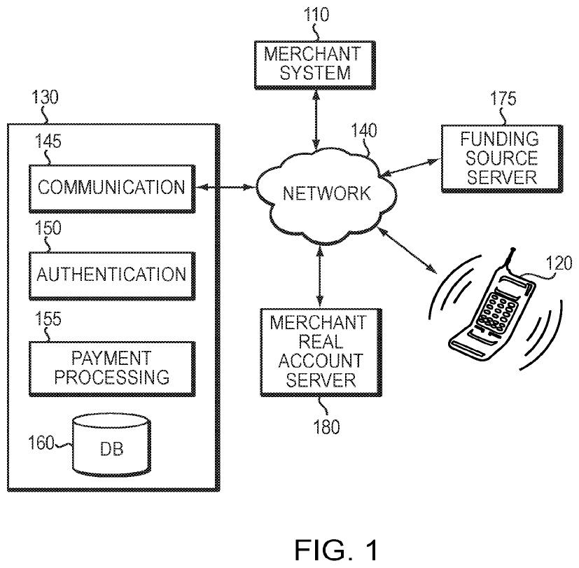

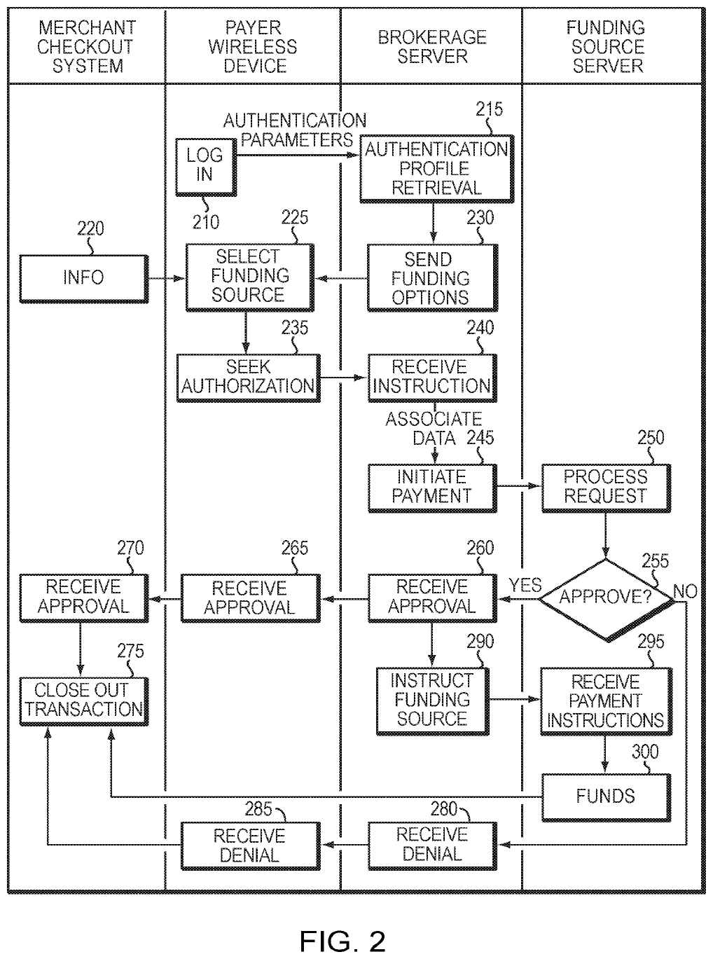

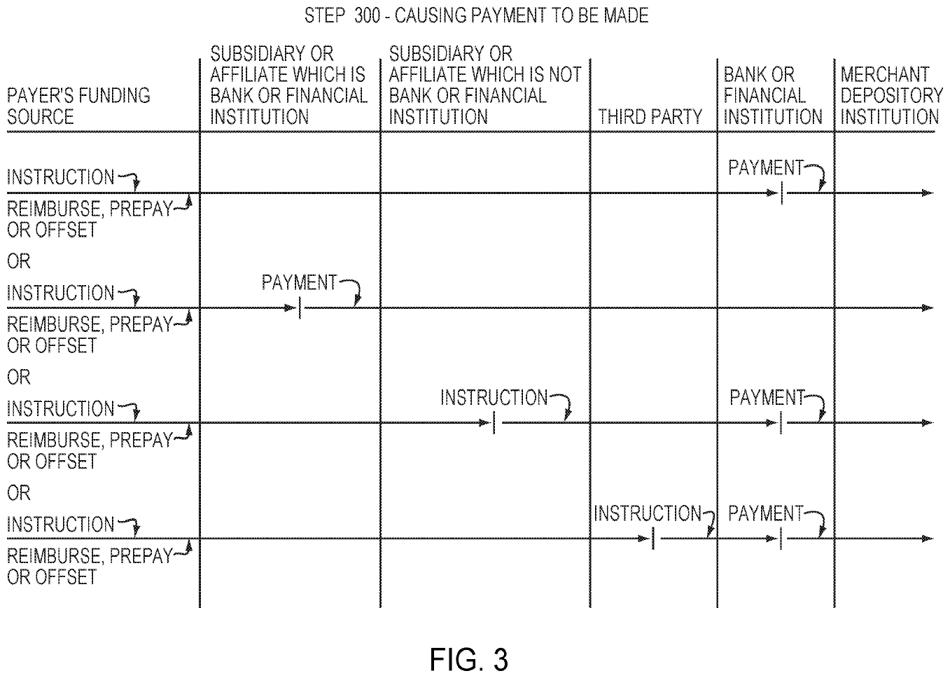

FIGS. 1-3 illustrate the architecture and operation of one exemplary embodiment of the invention, based on a typical purchase/payment transaction in a brick and mortar merchant location. In this example, the payee is a merchant and the payer is an individual purchaser shopping at the store.

With reference to FIG. 1, the merchant's computerized checkout system 110 may include a processing unit and a wireless communication facility for communicating with the payer's wireless electronic device 120, which may, for example, be a smart phone with a processing unit. The payer's device 120 may also include such a wireless communication facility and may store and run a secure software application provided by the payment broker's server 130 (another electronic device) to facilitate payment transactions. In particular, the payment broker's server 130 may include a communication facility 145 permitting communication with a network 140 e.g., the Internet and/or any other land-based or wireless telecommunication system or computer network—and, through network 140, with a funding source server 175, a merchant depository bank or financial institution's real-account server 180, a merchant system 110 and the payer's device 120. A funding source's server 175 or the real account server 180 of the merchant's depository bank or financial institution may also include a communication facility permitting communication with a network 140—e.g., the Internet and/or any other land-based or wireless telecommunication system or computer network. In addition, the payment broker's server 130 may contain an application 150 executing as a running process that enables the user to log in and authenticate himself or herself to the payment broker's server 130.

The payment broker's server 130 may include a payment application 155 executing as a running process and performing the brokerage tasks described herein, as well as a secure database 160 that may contain, for example, records for each authorized payer, payee, electronic device, secure software application, funding source(s), depository institution(s) and real account(s) or payer account type(s) as well as related payment causing to be made, sending, routing and/or clearing instructions, in each case without divulging the payer-selected funding source(s) and the payer-selected real account(s) of the payer to the payee's depository bank or financial institution and/or to the payee. These records may include, without limitation, identifying and authentication information for each payer, payee, electronic device, secure software application, funding source, depository institution, payment broker account reference number and associated real account or payer account type identifier. Based on these records and the preferences specified by a payer in a payment transaction, the payment broker's server 130 communicates, via network 140, with various servers 175 (i.e., electronic devices) operated by funding sources and hosting the payer's real accounts, and with various servers 180 (i.e., electronic devices) operated by depository banks or financial institutions hosting the payee's real accounts.

Databases such as the database 160 may be implemented in any suitable fashion as known in the art, and may be local (e.g., a partition within a server's hard disk, implemented on a separate network-attached drive, or on another server) or remote (e.g., implemented on a different network and accessed via the Internet using the communication facility). Secure databases utilize various strategies to maintain the security of data stored thereon. These include encryption of stored files, isolation from web-accessible servers, firewalls, security controls, and auditing protocols.

The payment broker's server 130, merchant system 110, funding source server 175 and the depository bank or financial institution server 180 hosting the merchant's depository real account may each include a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may include computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as, but not limited to, Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system or platform.

Any suitable programming language may be used to implement without undue experimentation the payment-processing operations described herein. Illustratively, the programming language used may include, but not be limited to, assembly language, Ada, APL, Basic, C, C++, C#, COBOL, dBase, Forth, FORTRAN, Java, Modula-2, Objective C, Pascal, Prolog, Python, REXX, Smalltalk and/or JavaScript for example. Further, it is not necessary that a single type of instruction or programming language be utilized in conjunction with the operation of the systems and methods of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, secure databases, network attached storage and the like. The storage media are typically connected to the system bus through a removable or non-removable memory interface.

The processing unit that executes commands and instructions may be a general purpose computer, but may also utilize any of a wide variety of other technologies including a special purpose computer, a microcomputer, mini-computer, mainframe computer, programmed micro-processor, micro-controller, peripheral integrated circuit element, a CSIC (customer-specific integrated circuit), ASIC (application-specific integrated circuit), a logic circuit, a digital signal processor, a programmable logic device such as an FPGA (field-programmable gate array), PLD (programmable logic device), PLA (programmable logic array), RFID processor, smart chip, or any other device or arrangement of devices that is capable of implementing the invention including the processes of the invention.

In one embodiment, the payer is an individual who has a relationship with the payment broker and has designated at least one available funding source and payer real account or account type to the payment broker. The payer has also assigned a payer-defined payment broker account reference number to correspond to the payer-designated real account or payer-designated account type. With reference to FIGS. 1-3, a representative transaction flow includes the following steps:
1. The payer spends some time shopping in the store. When ready, the payer presents a shopping cart or items to the merchant checkout location.
2. The payee (or in some cases the payer in self check-out situations) totals the cost of the items for purchase. The total cost and other necessary merchant data (including, but not limited to, a merchant identification or reference number stored in the payment broker's database 160, and which is associated with and identifies the particular merchant to the payment broker) are held in a typical POS terminal or other electronic device associated with merchant system 110. At this point, the payment process can begin.
3. The payer activates the payment broker provided secure software application on his or her electronic device 120, initiating step 210.
4. The payer authenticates himself or herself to the payment broker provided secure software application, which recognizes the payer. Alternatively, the payer uses the payment broker provided secure software application running on the payer's device 120 to communicate via a secure session with and authenticate himself or herself to the payment broker's server 130 (step 215). Any suitable authentication method or technology may be used, including but not restricted to, authentication via password/PIN entry and/or biometrics, digital signature functionality, or other two factor or three factor authentication all local to the electronic device, as well as additional known authentication processes at the payment broker's server 130 to ensure that the payer, electronic device, secure software application and designated payee are properly authenticated so that the processing and completion of the requested payment transaction can continue.
5. The merchant system 110 communicates with the payer's device 120 and transfers the total sales and related merchant data (such as merchant identification data and a payment broker account reference number for a merchant-requested depository institution and real account to receive the payment) to the payer's device 120 or in any other manner (e.g., by manual entry by the payer into the payer's device 120) (step 220). The payer can, of course, accept or reject such sales or related merchant data and enter other payer-determined data, as the payer controls the payment process.
6. The payer chooses which funding source and payer real account or account type to use for the payment (step 225). The payer can make this designation by sending the payment broker's server 130 his or her corresponding payment broker account reference number from a list previously established via the payment broker provided secure software application running on device 120. Alternatively, the payment broker's server 130 can communicate via a secure session with payer's device 120 and provide one or more payment broker account reference numbers for selection by the payer (step 230). (In some embodiments, the payer may have pre-specified payment preferences.) The payment broker provided secure software application running on the payer's electronic device 120 packages the total sales and merchant related data or payer-determined data, as applicable, with the payee identification or reference number, payer's electronic device data, payer's secure software application data, funding source identification, payment broker account reference number and/or other transaction data, and processes a payment instruction to the payment broker.
7. The payer's device 120 communicates the payment transmission to the payment broker's server 130 via a secure session over network 140 and sends the applicable payer, electronic device, secure software application, payee, funding source identification, depository institution, payment broker account reference numbers and other transaction data and the payer's payment instruction to the payment broker for authentication and payment authorization (step 235). The payment broker's server 130 recognizes the payer, electronic device, secure software application, payee, funding source, depository institution and/or payment broker account reference numbers and retrieves the associated records from database 160.
8. The payment broker's server 130 receives the payer's payment transmission (step 240), assigns payment transaction reference number(s) to the instruction and associates the supplied payment broker account reference numbers to the appropriate funding source, depository institution and the payer real account or account type known to and required by the funding source's server 175. In accordance with the payer's instructions, the payment broker's server 130 also associates payer and payee identification with information previously set up by the payer or payee, including payer funding source access preferences, funding source, depository institution and payer real account or account type identification, and any payer payment preferences and/or payer-selected or approved depository real account(s) of the payee.
9. The payment broker's server 130 provides further processing (step 245) to establish that the payer's funding source will authorize the requested payment transaction for or on behalf of the payer. This may include constructing an authorization request based upon funding source requirements. This may also include the payment broker's server 130 sending the authorization request to the funding source's server 175 requesting authorization (steps 250, 255).
10. The funding source's server 175 receives and processes the authorization request, including retrieving from a secure database and associating the payer-designated real account, or if a payer-designated account type has been provided, associating the payer's real account corresponding to the payer-designated account type that has been provided. The funding source server 175 approves the payment or declines the transaction (step 255) and sends its response via its communication facility to the payment broker's server 130 (step 260 or 280).
11. The payment broker's server 130 ensures that an authorization approval notification is sent to both the payer and the payee, which in this case is a merchant. An authorization approval notification and transaction reference number(s) (and possibly other identifiers, approval codes, day and time identifiers, or other information or data) may be sent by the payment broker's server 130 to the payer's device 120 (step 265), which sends it to the merchant system 110 (step 270). Alternatively, the authorization approval notification and transaction reference number(s) (and such other identifiers, approval codes, day and time identifiers or other information or data) may be sent by the payment broker's server 130 to the merchant system 110, which sends it to the payer's device 120, or the payment broker's server 130 may send the authorization approval notification and transaction reference number(s) (and such other identifiers, approval codes, day and time identifiers or other information or data) simultaneously to merchant system 110 and payer's device 120. Alternatively, the payer's device 120 or the merchant system 110 may receive the authorization approval notification and transaction reference number(s) (and such other identifiers, approval codes, day and time identifiers or other information or data) for display to the payer or merchant, who communicates it orally to the merchant or payer, as appropriate.
12. Provided the authorization is approved, the merchant closes out the purchase transaction (step 275) and the payer leaves with his or her merchandise. The merchant concludes the transaction using the information provided by the payment broker's server 130, which includes, without limitation, transaction reference number(s) and authorization approval (and possibly other identifiers, approval codes, day and time identifiers, or other information or data needed by the payer, payee (e.g., a merchant) or payment broker for their respective processing) for an appropriate audit (i.e., static and dynamic (i.e., real-time)) and security trail. The payment broker can or will guarantee the payment to the merchant via the payment broker's server 130 provided that there are no abnormal circumstances relating to the payment.
13. If the authorization is not approved, the transaction reference number(s) and denial (and possibly other identifiers, approval codes, day and time identifiers or other information or data) may be sent by the payment broker's server 130 to the payer's device 120 (step 280) which forwards it to the merchant system 110 (step 285). Alternatively, the transaction reference number(s) and denial (and such other identifiers, approval codes, day and time identifiers or other information or data) may be sent by the payment broker's server 130 directly to the merchant system 110, which forwards it to the payer's device 120. The payment broker's server 130 may send the transaction reference number(s) and denial (and such other identifiers, approval codes, day and time identifiers or other information or data) to both the merchant system 110 and the payer's device 120 by any other known communication means. The merchant and payer consult with each other as to the best manner to proceed in regard to the underlying purchase transaction (step 275).
14. The approval notification or denial of an authorization request can be sent by the payment broker's server 130 without the payment broker's server 130 divulging the payer-selected funding source(s) and payer-selected real account(s) of the payer to the payee's depository bank or financial institution and/or to the payee.
15. Assuming the payment has been authorized, the payment broker's server 130 instructs the funding source server 175 to cause the payment to be made from the payer-selected funding source and payer-selected real account of the payer (e.g., corresponding to the payer-selected account type if that is the only designation provided by the payment broker server 130 to the funding source server 175) to the payee's depository bank or financial institution server 180 and the payee's real account as described herein, without divulging to the payee's depository bank or financial institution and/or to the payee the payer-selected funding source and payer-selected real account of the payer (step 300).
16. If, after the payment has been made, the payer has a dispute with the merchant concerning the goods or services purchased, the payer can send a charge-back instruction to the payment broker's server 130 using payer's device 120 or through any other appropriate means to communicate with the payment broker. If and when permitted by applicable laws, regulations and rules, the payment broker's server 130 will instruct the funding source server 175 to cause the reversal of the entire prior payment transaction and cause a debit to be applied to the merchant's real account (via server 180) in the amount of the prior payment and a cause a credit in the same amount to be applied to the payer's real account at the funding source (via server 175) by, once again, supplying payer-identifying information (e.g., the payer, a payer-designated real account or payer-designated account type) to server 175.
17. However, to avoid fraud, credits for returns of products by a payer to a merchant (i.e., merchant returns) are ordinarily only processed by the payment broker if and when the merchant sends a message to the payment broker that the return has occurred and the merchant instructs the payment broker to reverse the entire prior payment transaction as described above. The merchant may send such a message and instruction using merchant system 110 to communicate with payment broker's server 130 or by any other means. As with charge-backs as described above, the payment broker's server 130 would instruct the funding source server 175 to cause the reversal of the entire prior payment transaction and to cause a debit to be applied in the amount of the prior payment to the merchant's real account (via server 180) and to cause a credit to be applied in the same amount to the payer's real account (identified as in the preceding step) at the payer-designated funding source (via server 175). Thus, in merchant return situations, the merchant essentially becomes the payer and the former purchaser becomes the payee of the described systems and methods in order to effectuate the merchant return transactions.

### Other Implementations

The systems and methods described herein provide a new model for a payer to cause a payment to be made to a payee. It will be understood that the systems and methods described herein are not limited to merchant/payer (e.g., purchaser) payment transactions but can be used for virtually any payment transaction where the payer wishes to cause a payment to be made to a payee from payer-selected funding source(s) and payer-selected real account(s) of the payer as described herein without divulging the payer-selected funding source(s) and payer-selected real account(s) of the payer to the payee's depository bank or financial institution and/or to the payee. Other transactions may include any transaction where there is payment from one person or legal entity to another person or legal entity (including money transfers, bill payments, utility payments, the payment of wages, contributions, donations, or any other form of payment or remittance of funds or transfer of value.)

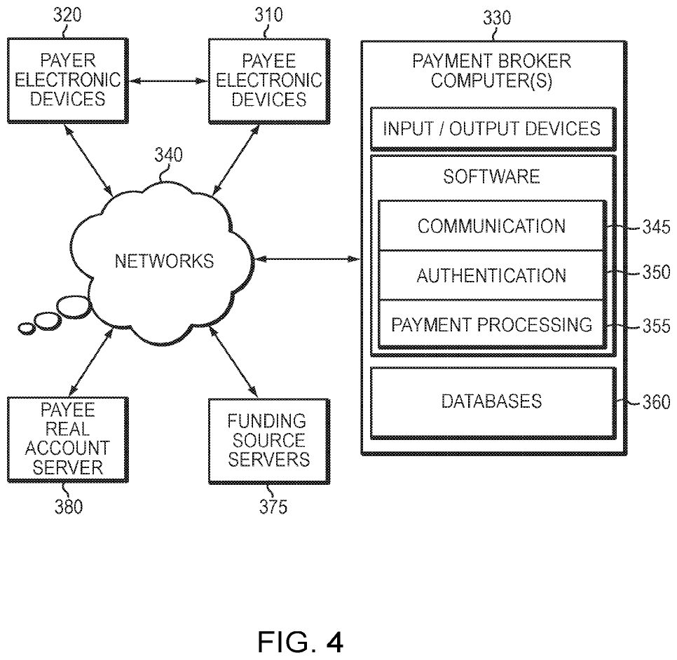

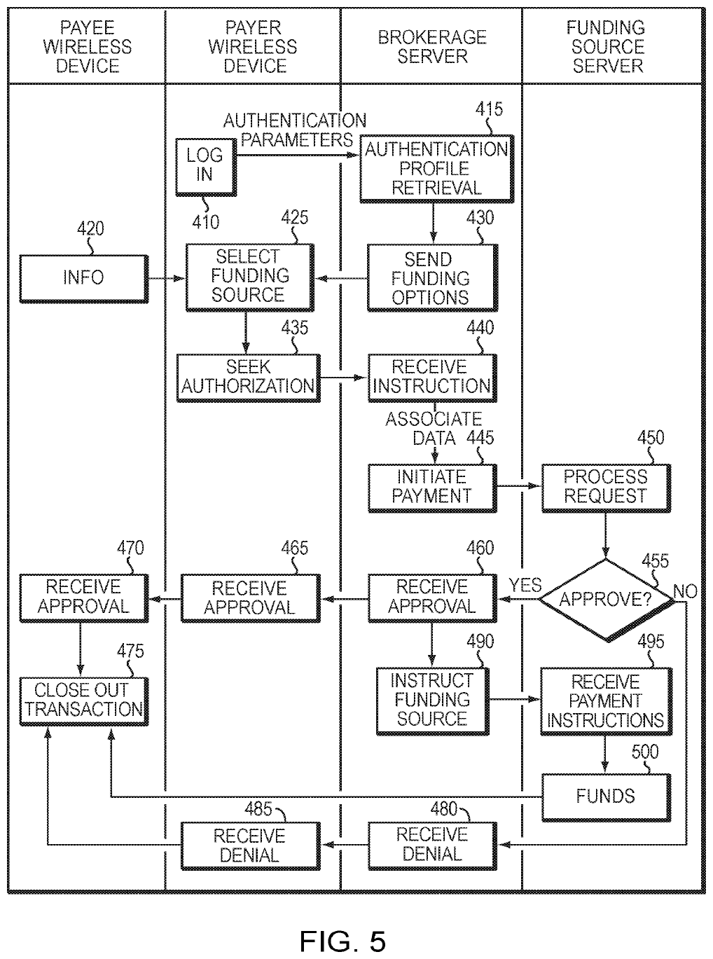

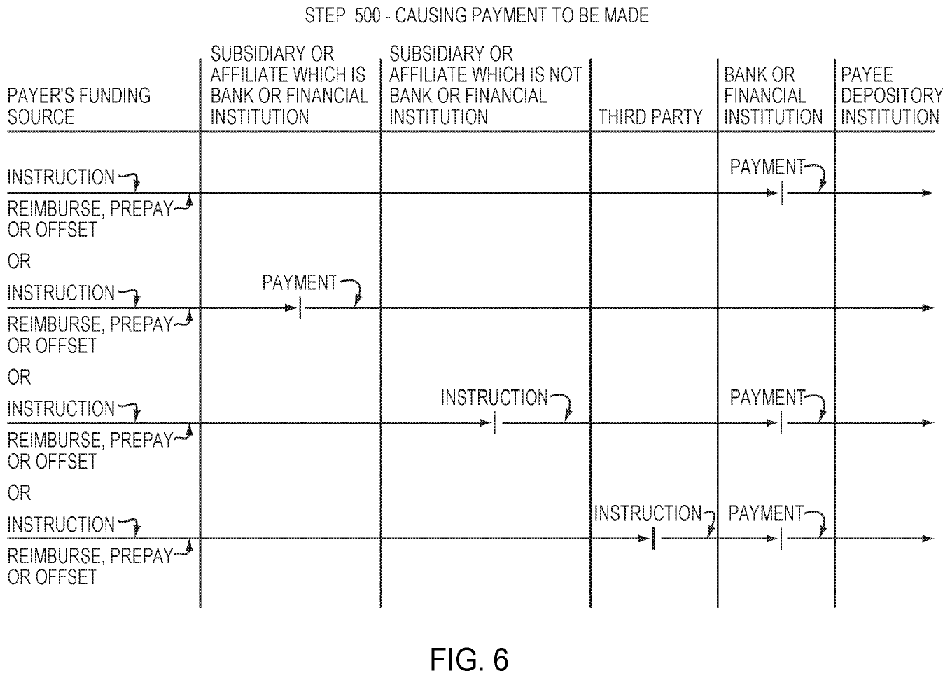

FIGS. 4-6 illustrate the architecture and operation of another exemplary embodiment of the invention, based on a typical payer-to-payee payment transaction. In this example, both the payee and the payer are individuals. The payment can be caused to be made for any purpose including, without limitation, for the purchase of goods or services; for the payment of debts, bills or wages; or for contributions or donations; or the payment can be caused to be made for any other conveyance or transfer of value whatsoever, including, without limitation, the provision or conveyance of goods or services; the provision or conveyance of a credit for goods or services; a transfer or license of content, information, software or intellectual property; or any other payment, remittance or transfer of funds or value whatsoever, whether now in existence or arising in the future.

With reference to FIG. 4, the payee's wireless electronic device 310 may include a processing unit and wireless communication facility for communicating with the payer's wireless electronic device 320, which may, for example, be a smart phone with a processing unit. The payer's device 320 may also include such a wireless communication facility and may store and run a secure software application provided by the payment broker's server 330 (another electronic device) to facilitate payment transactions. In particular, the payment broker's server 330 may include a communication facility 345 permitting communication with a network 340—e.g., the Internet and/or any other land-based or wireless telecommunication system or computer network—and, through network 340, with a funding source server 375, a payee depository bank or financial institution real account server 380, a payee's device 310 and the payer's device 320. The funding source's server 375 or the real account server 380 of the payee's depository bank or financial institution may also include a communication facility permitting communication with a network 340—e.g., the Internet and/or any other land-based or wireless telecommunication system or computer network. In addition, the payment broker's server 330 may contain an application 350 executing as a running process that enables the user to log in and authenticate himself or herself to the payment broker's server 330.

The payment broker's server 330 may include a payment application 355 executing as a running process and performing the brokerage tasks described herein, as well as a secure database 360 that may contain, for example, records for each authorized payer, payee, electronic device, secure software application, funding source(s), depository institution(s), and real account(s) and payer account types as well as related payment causing to be made, sending, routing and/or clearing instructions, in each case without divulging the payer-selected funding source(s) and the payer-selected real account(s) of the payer to the payee's depository bank or financial institution and/or to the payee. These records may include, without limitation, identifying and authentication information for each payer, payee, electronic device, secure software application, funding source, depository institution, payment broker account reference number and associated real account or payer account type identifier. Based on these records and the preferences specified by a payer in a payment transaction, the payment broker's server 330 communicates, via network 340, with various servers 375 (i.e., electronic devices) operated by funding sources and hosting the payer's real account(s), and with various servers 380 (i.e., electronic devices) operated by depository banks or financial institutions hosting the payee's real accounts.

Databases such as the database 360 may be implemented in any suitable fashion as known in the art, and may be local (e.g., a partition within a server's hard disk, implemented on a separate network-attached drive, or on another server) or remote (e.g., implemented on a different network and accessed via the Internet using the communication facility). Secure databases utilize various strategies to maintain the security of data stored thereon. These include encryption of stored files, isolation from web-accessible servers, firewalls, security controls, and auditing protocols.

The payment broker's server 330, funding source server 375 and the depository bank or financial institution server 380 hosting the payee's depository real account may each include a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may include computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as, but not limited to, Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system or platform.

Any suitable programming language may be used to implement without undue experimentation the payment-processing operations described herein. Illustratively, the programming language used may include, but not be limited to, assembly language, Ada, APL, Basic, C, C++, C#, COBOL, dBase, Forth, FORTRAN, Java, Modula-2, Objective C, Pascal, Prolog, Python, REXX, Smalltalk and/or JavaScript for example. Further, it is not necessary that a single type of instruction or programming language be utilized in conjunction with the operation of the systems and methods of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, secure databases, network attached storage and the like. The storage media are typically connected to the system bus through a removable or non-removable memory interface.

The processing unit that executes commands and instructions may be a general purpose computer, but may also utilize any of a wide variety of other technologies including a special purpose computer, a microcomputer, mini-computer, mainframe computer, programmed micro-processor, micro-controller, peripheral integrated circuit element, a CSIC (customer-specific integrated circuit), ASIC (application-specific integrated circuit), a logic circuit, a digital signal processor, a programmable logic device such as an FPGA (field-programmable gate array), PLD (programmable logic device), PLA (programmable logic array), RFID processor, smart chip, or any other device or arrangement of devices that is capable of implementing the invention including the processes of the invention.

With reference to FIGS. 4-6, the payer is an individual who has a relationship with the payment broker and has designated at least one available funding source and payer real account or account type to the payment broker. The payer has also assigned a payer-defined payment broker account reference number to correspond to the payer-designated real account or payer-designated account type. In one embodiment, a representative transaction includes the steps of:
1. The payer wishes to make a payment to a payee who is also an individual.
2. The necessary payee data (including, but not limited to, a payee identification or reference number stored in the payment broker's database 360, and which is associated with and identifies the particular payee to the payment broker) are held in the payee's electronic device 310 or otherwise provided to the payer. At this point, the payment process can begin.
3. The payer activates the payment broker provided secure software application on his or her electronic device 320, initiating step 410.
4. The payer authenticates himself or herself to the payment broker provided secure software application, which recognizes the payer. Alternatively, the payer uses the payment broker provided secure software application running on the payer's device 320 to communicate via a secure session with and authenticate himself or herself to the payment broker's server 330 (step 415). Any suitable authentication method or technology may be used, including but not restricted to, authentication via password/PIN entry and/or biometrics, digital signature functionality, or other two factor or three factor authentication all local to the electronic device, as well as additional known authentication processes at the payment broker's server 330 to ensure that the payer, electronic device, secure software application and designated payee are properly authenticated so that the processing and completion of the requested payment transaction can continue.
5. The payee's electronic device 310 communicates with the payer's device 320 and transfers payee data (such as payee identification data and a payment broker account reference number for a payee-requested depository institution and real account to receive the payment) to the payer's device 320 or in any other manner (e.g. by manual entry by the payer into the payer's device 320) (step 420). The payer can, of course, accept or reject such payee data and enter other payer-determined data, as the payer controls the payment process.
6. The payer chooses which funding source and payer real account or account type to use for the payment (step 425). The payer can make this designation by sending the payment broker's server 330 his or her corresponding payment broker account reference number from a list previously established via the payment broker provided secure software application running on device 320. Alternatively, payment broker's server 330 can communicate via a secure session with payer's device 320 and provide one or more payment broker account reference numbers for selection by the payer (step 430). (In some embodiments, the payer may have pre-specified some payment preferences.) The payment broker provided secure software application running on the payer's electronic device 320 packages the payee's transaction data or payer-determined data, as applicable, with the payee identification or reference number, payer's electronic device data, payer's secure software application data, funding source identification, payment broker account reference number and/or other transaction data, and processes a payment instruction to the payment broker.
7. The payer's device 320 communicates the payment transmission to the payment broker's server 330 via a secure session over network 340 and sends the applicable payer, electronic device, secure software application, payee, funding source identification, depository institution, payment broker account reference numbers and/or other transaction data and the payer's payment instruction to the payment broker for authentication and payment authorization (step 435). The payment broker's server 330 recognizes the payer, electronic device, secure software application, payee, funding source, depository institution and/or payment broker account reference numbers and retrieves the associated records from database 360.
8. The payment broker's server 330 receives the payer's payment transmission (step 440), assigns a payment transaction reference number to the instruction and associates the supplied payment broker account reference numbers to the appropriate funding source, depository institution and the payer real account or account type known to and required by the funding source's server 375. In accordance with the payer's instructions, the payment broker's server 330 also associates payer and payee identification with information previously set up by the payer or payee, including payer funding source access preferences, funding source, depository institution, and payer real account or account type identification, and any payer payment preferences and/or payer-selected or approved depository real account(s) of the payee.
9. The payment broker's server 330 provides further processing (step 445) to establish that the payer's funding source will authorize the requested payment for or on behalf of the payer. This may include constructing an authorization request based upon funding source requirements. This may also include payment broker's server 330 sending the authorization request to the funding source's server 375 requesting authorization (steps 450, 455).
10. The funding resource's server 375 receives and processes the authorization request, including retrieving from a secure database and associating the payer-designated real account, or if a payer-designated account type has been provided, associating the payer's real account corresponding to the payer-designated account type that has been provided. The funding source server 375 approves the payment or declines the transaction (step 455) and sends its response via its communication facility to the payment broker's server 330 (step 460 or 480).
11. The payment broker's server 330 ensures that an authorization approval notification is sent to both the payer and the payee. An authorization approval notification and transaction reference number(s) (and possibly other identifiers, approval codes, day and time identifiers, or other information or data) may be sent by the payment broker's server 330 to the payer's device 320 (step 465), which sends it to the payee's device 310 (step 470). Alternatively, the authorization approval notification and transaction reference number(s) (and such other identifiers, approval codes, day and time identifiers or other information or data) may be sent by the payment broker's server 330 to the payee's device 310, which sends it to the payer's device 320, or the payment broker's server 330 may send the authorization approval notification and transaction reference number(s) (and such other identifiers, approval codes, day and time identifiers or other information or data) simultaneously to the payee's device 310 and payer's device 320. Alternatively, the payer's device 320 or the payee's device 310 may receive the authorization approval notification and transaction reference number(s) (and such other identifiers, approval codes, day and time identifiers or other information or data) for display to the payer or payee, who communicates it orally to the payee or payer, as appropriate.
12. Provided the authorization is approved and using the information provided by the payment broker's server 330, which includes, without limitation, transaction reference number(s) (and possibly other identifiers, approval codes, day and time identifiers, or other information or data needed by the payer, payee or payment broker for their respective processing) for an appropriate audit (i.e., static and dynamic (i.e., real-time)) and security trail, the payee concludes whatever transaction or matter the subject payment was intended for (step 475). The payment broker can or will guarantee the payment to the payee via the payment broker's server 330 provided that there are no abnormal circumstances relating to the payment.
13. If the authorization is not approved, the transaction reference number(s) and denial (and possibly other identifiers, approval codes, day and time identifiers or other information or data) may be sent by the payment broker's server 330 to the payer's device 320 (step 480) which forwards it to the payee's device 310 (step 485). Alternatively, transaction reference number(s) and denial (and such other identifiers, approval codes, day and time identifiers or other information or data) may be sent by the payment broker's server 330 directly to the payee's device 310, which forwards it to the payer's device 320 or the payment broker's server 330 may send the transaction reference number(s) and denial (and such other identifiers, approval codes, day and time identifiers or other information or data) to both the payee device 310 and the payer device 320 by any other known communication means. The payee and payer consult with each other as to the best manner to proceed in regard to the transaction or matter the payment was intended for (step 475).
14. The approval notification or denial of an authorization request can be sent by the payment broker's server 330 without the payment broker's server 330 divulging the payer-selected funding source(s) and payer-selected real account(s) of the payer to the payee's depository bank or financial institution and/or to the payee.
15. Assuming the payment has been authorized, the payment broker's server 330 instructs the funding source server 375 to cause the payment to be made from the payer-selected funding source and payer-selected real account of the payer ((e.g., corresponding to the payer-selected account type if that is the only designation provided by the payment broker server 330 to the funding source server 375) to the payee's depository bank or financial institution server 380 and the payee's real account as described herein, without divulging to the payee's depository bank or financial institution and/or to the payee the payer-selected funding source and payer-selected real account of the payer (step 500).
16. If, after the payment has been made, the payer has a dispute with the payee concerning the underlying transaction or matter, the payer can send a charge-back instruction to the payment broker's server 330 using payer's device 320 or through any other appropriate means to communicate with the payment broker. If and when permitted by applicable laws, regulations and rules, the payment broker's server 330 will instruct the funding source server 375 to cause the reversal of the entire prior payment transaction and cause a debit to be applied to the payee's real account (via server 380) in the amount of the prior payment and cause a credit in the same amount to be applied to the payer's real account (identified as in the preceding step) at the funding source (via server 375).

### Additional Functions, Features and Characteristics

In addition to the representative transaction flow described above with regard to a payee that may be a merchant, in another embodiment the payer shops at a merchant Internet web site or other electronic storeroom where payers can purchase goods or services from the merchant. Thus, a point of sale can mean either a physical storefront (a “brick and mortar”) or an Internet web site where payers can shop and where there is an electronic device (such as a POS terminal, cash register, personal computer, etc.) or an Internet web site and associated server that can communicate via wireless or wired networks or other communication means whether now known or developed in the future with other electronic devices such as personal computers or handheld electronic devices such as iPads, iPods or mobile phones.

In one implementation, the merchant's electronic device is capable of sending data to and receiving data from the payer's handheld or portable electronic device. In another implementation, the appropriate payee information is manually entered into the payer's electronic device which can be as low-tech as a conventional touch-tone or rotary telephone in communication with the payment broker. Alternatively, the payer may call or visit and speak with a customer-service representative at the payment broker and orally communicate and receive the needed information necessary to process and complete the requested payment, with the customer-service representative entering the needed information into the payment broker's server through conventional means.

Likewise, a payee can also access and communicate with the systems and methods described herein by similarly calling, visiting and speaking with a customer-service representative of the payment broker. As described above, any means by which the payer or payee can communicate with the payment broker can be used to gather and relay the necessary information by and between the payment broker and the payer and/or payee in order to process and complete the requested payment.

In one embodiment, the payer's electronic device can send data to and receive data from the payee's electronic device (such as a POS terminal, cash register or mobile phone.) The payer's electronic device runs a secure software application provided by the payment broker that can contain pre-configured information about the payer and the payer's payment preferences (including payer-designated funding source(s), depository institution(s) and payment broker account reference number(s)) as well as the ability to package sales ticket or other payee or payer information, initiate a payment instruction in accordance with the payer's requirements, and send or respond to data required to complete the payer-instructed payment. In some implementations, a given payment broker account reference number may represent (i) a payer-selected funding source and payer-selected real account or account type therein, (ii) a payer-selected or approved payee depository institution and payer-selected or approved real account of the payee therein, or (iii) a payee-requested depository institution and payee-requested real account of the payee therein.

The payer-designated funding source(s) and real account(s) and, in most cases, the method of payment can be opaque to the payee since the payee will not know them, have any visibility or control over them or any concerns about them. The payee receives the payment regardless of whether the payer chooses a credit card account, debit card account, checking account, savings account, loyalty account, value account, etc. or any other funding source and real account capable of making the desired payment, and regardless of how the payment is caused to be made to the payee as described herein, in each case without divulging the payer-selected funding source(s) and payer-selected real account(s) of the payer to the payee's depository bank or financial institution and/or to the payee.

The payer may activate the payment broker provided secure software application on their electronic device. In one implementation, the activation represents to the payee that the payer's electronic device is ready for the transaction and prepares the secure software application on the payer's device to receive sales and other payee information from the payee's electronic device including, but not limited to, a POS terminal or cash register in the case of a payee that is a merchant. In this implementation, the merchant selects an option on its electronic device that causes the sales data, merchant identification or reference number information and other data to be sent to the payer's electronic device. Once this merchant data and information is captured by the payer's electronic device, it is packaged with the payer's transaction data and related information as well as the payer's payment instruction for transmission to the payment broker's server. The resulting payment transmission is then sent via a secure session to the payment broker's server for further processing and routing to the server(s) of the payer-designated funding source(s) as described herein. In some implementations, the payment broker furnishes the payee (including a merchant) with a suitable secure software application to be run on the payee's electronic device that facilitates this payee to payer data and information transmission.

Accordingly, in this implementation, the merchant's electronic device transmits the sales and merchant data to the payer's electronic device using some standard communication interface/protocol preferred by the industry. For example, these may be Bluetooth, RFID, Near Field Communications (NFC) and others that the industry adopts as standard communication interfaces/protocols and that are available for both the payee's and payer's electronic devices. For present purposes, the term NFC is used generally to represent any of the acceptable standard interface/communication protocols that currently exist or that may exist in the future. However, in this implementation, the only requirement is that both the payee's and the payer's electronic devices implement a compatible interface/protocol and can communicate with each other using that standard.

The payee's electronic device may contain payee transaction data that includes, without limitation, an amount, payee identification number, payee transaction reference number, date and time stamp, payee electronic device data, payee secure software application data, payee authentication data, and/or any other payee data useful to the payment broker's server to authenticate the payee, and/or the payee's electronic device and/or secure software application. Once the payee's electronic device transmits the sales, payee identification and other payee-related data and information, the payer's electronic device signals good receipt back to the payee's electronic device.

The payer's electronic device may contain the payer transaction data that includes, without limitation, payer identification data, a payer transaction reference number, date and time stamp, funding source(s) and real account(s) or account type(s) selected by the payer for the payment, payer electronic device data, payer-selected or approved real account(s) of the payee to receive the payment, payer secure software application data, and any other payer data useful to the payment broker's server to authenticate the payer and/or the payer's electronic device and/or secure software application and process the payer's payment instruction.

The payment broker provided secure software application running on the payer's electronic device readies the payment transaction for transmission to the payment broker's server for further processing and routing to the server(s) of the payer-selected funding source(s) as described herein. The payer can select a single funding source or multiple funding sources and one or more real accounts or account types for the desired payment (i.e., may instruct the payment broker's server to implement a split payment) or the payer may instruct the payment broker's server to instruct a funding source server to cause a payment to be made to a payee as described herein from certain preferred real account(s) or account type(s) generally or only with respect to specific payees (e.g., certain merchants or types or categories of merchants), in each case without divulging the payer-selected funding source(s) and payer-selected real account(s) of the payer to the payee's depository bank or financial institution and/or to the payee. The payer can also instruct the payment broker's server as to which depository institution(s) and real account(s) of the payee the payer wants the desired payment(s) to be caused to be made, in each case without divulging the payer-selected funding source(s) and payer-selected real account(s) of the payer to the payee's depository bank or financial institution and/or to the payee, with the payer and not the payee making the selection, providing the instructions and controlling the payment transaction.

The payer's electronic device sends the payment transmission to the payment broker's server via a secure session. The common security/encryption protocols found on most mobile phones and other handheld devices such as 3G, 4G, Wireless, etc. can be used to establish a secure session with the payment broker's server.

In another implementation, the payee's electronic device communicates via a secure session and sends the payee transaction related data to the payment broker's server. The payment broker's server communicates via a secure session and sends a message to the payer's electronic device requesting the payer's electronic device to send the payer's transaction related data and payer's payment instruction to the payment broker's server. The secure software application on the payer's electronic device responds by sending the payer's transaction related data and payer's payment instruction via a secure session. The payment broker's server processes the payee's transaction related data and the payer's transaction related data and the payer's payment instruction and sends an authorization request and/or payment instruction to the server(s) of the payer-designated funding source(s) as instructed by the payer to cause the payment to be made to the payee as described herein without divulging the payer-selected funding source(s) and payer-selected real account(s) of the payer to the payee's depository bank or financial institution and/or to the payee. Alternatively, the payer's electronic device communicates via a secure session and sends the payer's transaction related data and payment instruction to the payment broker's server. The payment broker's server communicates via a secure session and sends a message to the payee's electronic device requesting the payee's electronic device to send the payee's transaction related data to the payment broker's server. The secure software application on the payee's electronic device responds by sending the payee's transaction related data via a secure session to the payment broker's server. The payment broker's server processes the payee's transaction related data and payer's transaction related data and payer's payment instruction and sends via a secure session an authorization request and/or payment instruction to the server(s) of the payer-designated funding source(s) as instructed by the payer to cause the payment to be made to the payee as described herein without divulging the payer-selected funding source(s) and payer-selected real account(s) of the payer to the payee's depository bank or financial institution and/or to the payee.

In one implementation, the payment broker's server obtains from one or more secure databases of or controlled by the payment broker the payer's real account or account type information and method of payment to be used by the payer-selected funding source(s) and sends that information to the funding source server(s) via secure session(s). In another implementation, the payment broker's server can access the relevant secure database(s) of the payer-designated funding source(s) in order to obtain some or all of the necessary information and data that it needs in order to process, direct and control the requested payment transaction as instructed by the payer. In yet another implementation, as requested by a payer, a payment broker's server can send one or more payer-selected funding source server(s) one or more authorization request(s) each comprising information identifying the payer, a payer account type and a payment amount but not identifying a real account of the payer. In response to an authorization request by the payment broker's server, the funding source server can query a secure database of the funding source in order to associate the payer-indicated payer account type with a corresponding real account of the payer and respond to the authorization request. In a further implementation, as requested by a payer, a payment broker's server can send one or more payer-selected funding source server(s) one or more payment instruction(s) each comprising information identifying the payer, a payer account type, a payment amount and a payment destination but not identifying a real account of the payer. In response to a payment instruction by the payment broker's server, the funding source server can query a secure database of the funding source in order to associate the payer's indicated payer account type with a corresponding real account of the payer and can also query a secure database in order to select appropriate routing instructions as needed in order to cause the payment to be made as instructed. Once the payer-selected funding source server has received, obtained, associated or selected all information needed to authorize or to cause the payment to be made to the payee as instructed by the payment broker's server, the funding source server can authorize the payment or can cause the payment to be made to the payee in accordance with the relevant instruction.

For example, if the payer wants to pay with funds from his or her bank checking account, the payment broker's server communicates with the server of the payer-selected funding source via a secure session to ascertain if the payment can be made. This authorization request can be performed using existing methods known in the industry to perform a check with the funding source server and, if needed, the funding source server as part of the authorization process can query a secure database of the funding source in order to associate the payer-designated payer account type with a corresponding real account of the payer. If the funds are available, authorization will be sent back to the payment broker's server via a secure session. The payment broker's server can then transmit via a secure session an approval notification to the payment broker provided secure software application running on the payer's electronic device or otherwise communicate the information via a secure session to the payer and/or payee as described herein. The approval notification or denial of an authorization request can be sent by the payment broker's server without the payment broker's server divulging the payer-selected funding source(s) and payer-selected real account(s) of the payer to the payee's depository bank or financial institution and/or to the payee.

The functions performed by the payment broker's server and secure database(s) may be combined into a single server with or without separate secure database(s). In addition, if the payment broker is also acting as a funding source and hosting one or more real account(s) of the payer, then for a given payment, the functions performed by the payment broker's server and the funding source server may be combined into a single server with or without separate secure database(s) implementation, and thus without a separate server for the funding source server function.

The payer's mobile phone (i.e., hand held electronic device) informs the merchant's electronic device that the transaction will be honored and the merchant can release the goods to the payer. The payment broker can or will guarantee the payment to the merchant provided that there are no abnormal circumstances relating to the payment. The payee may possess an electronic device capable of processing the sales information and can (preferably) communicate with the payer's electronic device using a compatible interface/protocol. In one implementation, this electronic device does not require further communication capability. The payer possesses an electronic device that is (preferably) capable of communicating with the payee's electronic device. The payer's electronic device also communicates with and sends the necessary data and the payer's payment instruction to the payment broker's server via a secure session, which, in turn, processes and sends the authorization request and/or payment causing to be made instructions to the server of the payer-selected funding source in order to cause the payment to be made to the payee as described herein as instructed by the payer, without divulging the payer-selected funding source(s) and payer-selected real account(s) of the payer to the payee's depository bank or financial institution and/or to the payee. If the authorization request is approved, the payment broker's server instructs the funding source server to cause the payment to be made to the payee as described herein as instructed by the payer, without divulging the payer-selected funding source(s) and payer-selected real account(s) of the payer to the payee's depository bank or financial institution and/or to the payee.

The payee can also have a typical merchant relationship with the payment broker as found in the credit card industry today; it is not, however, a requirement that the payee have a credit card relationship with the payment broker. Typical merchants or businesses that accept credit cards for payment have relationships with merchant banks or ISOs for payment authorization and/or clearing functions. In some embodiments, the payment broker or its affiliate may also be a merchant processor for typical credit and debit card transactions and a merchant may have a merchant relationship with the payment broker or its affiliate totally distinct from its relationship with the payment broker in regard to the payment systems and methods described herein.

The merchant can submit normal credit card authorization requests through the typical gateways found today (e.g., for MasterCard and Visa). However, if the payer, who also has a relationship with the payment broker, indicates that the payer would prefer to use the payer's electronic device to cause the payment to be made to the payee as described herein, then those payment systems and methods can be invoked and used. The payer chooses which funding source(s) and real account(s) or account type(s) to use, then in one implementation the merchant sales ticket data, merchant identification data and a merchant requested depository institution and real account are captured by the payer's electronic device. The necessary data and payer's payment instruction are then packaged and routed through whatever electronic or communication networks are available for the payer and the payment transmission may be sent via a secure session to the payment broker's server for processing as described herein.

In another implementation, the payer chooses the funding source(s), depository institution(s) and real account(s) or account type(s) that he or she would like to use from his or her electronic device, captures the merchant's (or other payee's) data and initiates and routes the packaged transaction and related data with the payer's payment instruction through whatever electronic or communication networks are provided for the merchant (or payee) with the transaction being sent via a secure session in this manner to the payment broker's server for processing as described herein. In some implementations, the payment broker's server furnishes the merchant (or other payee) with a suitable secure software application that facilitates the payer's use of the merchant's (or payee's) network transmission option. Thus, virtually any suitable electronic or telecommunications system or computer network or facility may be utilized by the payer's electronic device to communicate via a secure session with the payment broker's server.

A given individual or entity may be a payer in one payment transaction and a payee in another payment transaction. Indeed, a given individual or entity may be both the payer and the payee in a given payment transaction such as when a payer instructs the payment broker's server to cause a payment to be made from one or more of the payer's funding source(s) and real account(s) to another real account of the payer at a payer-selected or approved depository institution. However, for each payment transaction there is always a payer and a payee, which payee may or may not be a merchant. Accordingly, the payment broker provided secure software application that runs on an electronic device may in some implementations include a payer mode of operation and a payee mode of operation, either of which modes of operation may be selected by the user or by the payment broker's server depending upon the circumstances. Alternatively, the user or the payment broker's server could also designate only a single mode of operation for a given instance of the secure software application on a given electronic device. Whichever mode of operation is selected, the payment broker provided secure software application performs the tasks identified herein for the mode of operation that it is then performing.

When operating in a payee mode of operation, the payment broker provided secure software application may facilitate communications between the payee's electronic device and the payer's electronic device, between the payee's electronic device and the payment broker's server via a secure session, and possibly also between the payer's electronic device and the payment broker′ server via a secure session through a network or other communications system available to the payee. Further, when operating in a payee mode of operation, the payment broker provided secure software application may (in some implementations) package payee information, payer information and the payer's payment instruction and transmit the package to the payment broker's server via a secure session on behalf of the payer via a network or other communications system available to the payee. For security purposes, the payer's information and the payer's payment instruction can be transmitted to the payee in encrypted or other secure form for packaging with the payee's information for further transmission by the payee's electronic device to the payment broker's server via a secure session on the payer's behalf. Of course, the payee's information can also be encrypted or otherwise made secure to reduce similar security and privacy concerns.

However, when operating in a payee mode of operation, the payment broker provided secure software application may not undertake the payer-controlled operations described above that are typically implemented via the payer's electronic device or by the payment broker's server such as enabling the payer to select among available funding sources and payment broker account reference numbers associated with the payer's funding source(s), real account(s) or account type(s), enabling the payer to select or approve the depository institution(s) and real account(s) of the payee to which the payments are to be caused to be made, processing and formatting the payer's payment instructions to the payment broker's server or, in the case of the payment broker's server, processing and sending authorization requests and/or payment causing to be made instructions as described herein to the server(s) of the payer-selected funding source(s) as described herein, in each case without divulging the payer-selected funding source(s) and the payer-selected real account(s) of the payer to the payee's depository bank or financial institution and/or to the payee. Those payer-controlled operations are facilitated by the payment broker provided secure software application when operating in a payer mode of operation or by the payment broker's server when acting for or on behalf of the payer and at the payer's instruction.

Further, in order to reduce the risk of fraud, theft or misappropriation, it may in certain circumstances be appropriate for the payment broker's server to authenticate the payer's electronic device and/or the payee's electronic device and/or given instances of the payment broker provided secure software application operating in a payer and/or payee mode. The payment broker's server can further assure that a payment transmission purportedly sent from a payer to the payment broker's server is in fact genuine and originates from the payer that it purports to be from, regardless of whether transmitted by the payer's electronic device via a secure session through a payee-accessible computer network or telecommunications system via an instance of the payment broker provided secure software application operating in a payee mode. In addition, it should be noted that payment broker provided secure software applications can be sold, licensed or otherwise provided to the payer or the payee by the payment broker directly, via electronic or wireless transmission or by other conventional delivery systems, or via other authorized third-party delivery or transmission systems such as the Apple Store or Google Apps, etc.

The payee relationship with the payment broker can be very minimal and can, for example, consist of the payee simply providing the payment broker with payee identification information and a payee requested real account information for a payee real account at a depository institution into which a payment can be caused to be made. Indeed, in some embodiments the payee may have no formal relationship with the payment broker with the payer providing the payee identification information and payee real account information for a real account of the payee at a depository institution into which a payment can be caused to be made, in each case without divulging the payer's funding source(s) and payer-selected real account(s) of the payer to the payee's depository bank or financial institution and/or to the payee. Essentially embodiments of the present invention can be payer controlled, and the payer can instruct the payment broker's server to instruct the server of the payer-selected funding source to cause the payer's payment to be made as described herein, without divulging the payer-selected funding source and payer-selected real account(s) of the payer to the payee's depository bank or financial institution and/or to the payee, to whoever or whatever the payer so instructs (including to the payer when the payer is also the payee that receives the payment), as long as the payment broker has been provided with payee identification information and a real account of the payee into which the payment can be caused to be made.

Further, the payee relationship with the payment broker may be more extensive, depending upon the payee and/or types of underlying transactions the systems and methods described herein are intended to support and that, accordingly, the payer can instruct the payment broker to use its server to accommodate a more extensive payee relationship. Thus, most payees (including merchants) may have a much more extensive relationship with the payment broker as the systems and methods described herein are configured to support the underlying purchase, money transfer, bill payment, utilities payment, wages payment or any other payment, remittance or transfer transactions, etc. that the payer and payee wish to undertake and effect, and will likely be subject to a variety of applicable laws, regulations and rules, audit requirements (both static and dynamic (e.g., real-time)) and funding source and third-party routing and/or clearing system rules and requirements that will need to be complied with in connection therewith. In one embodiment, the systems and methods described herein can be configured as instructed by the payer so that the payment broker's server supports the static and dynamic (e.g., real-time) audit requirements of large merchants pertaining to the underlying purchase and payment transactions undertaken. In another embodiment, a payee (e.g., a merchant) may designate to the payment broker's server a payee-requested specific real account of the payee to be utilized for charge back or merchant return situations, which requested real account is different from the payee's requested real account where payments are to be caused to be made, and the payer could instruct the payment broker to use its server to accommodate this payee-requested arrangement. As previously mentioned, in a merchant return situation, the merchant essentially becomes the payer and the former purchaser becomes the payee of the described systems and methods in order to effectuate the merchant return transaction.

In addition, the payer's relationship with the payment broker may be more or less extensive. As described above and in addition to the more typical relationship of a payer and the payment broker as described herein, a payer may register multiple electronic devices with the payment broker with each such device available for the payer's use in communicating with or instructing the payment broker's server. In addition, a payer may also register multiple agents or users, each authorized by the payer to communicate with and instruct the payment broker's server for or on the payer's behalf in order to instruct the server(s) of the payer-selected funding source(s) to cause payments to be made to payee(s) as described herein from one or more funding source(s) and real account(s) of the payer without divulging the payer-selected funding source(s) and payer-selected real account(s) of the payer to the payee's depository bank or financial institution and/or to the payee(s). For example, a payer may authorize his or her accountant to act as his or her agent to communicate with and instruct the payment broker's server for or on the payer's behalf in order to instruct the server(s) of payer-selected funding source(s) to cause payment(s) to be made to payee(s) as described herein from one or more funding source(s) and real account(s) of the payer without divulging the payer-selected funding source(s) and payer-selected real account(s) of the payer to the payee's depository bank or financial institution and/or to the payee(s). As another example, an elderly person may authorize her son or daughter to communicate with and instruct the payment broker's server on the elderly person's behalf to instruct the server(s) of payer-selected funding source(s) to cause payment(s) to be made to payee(s) as described herein from the elderly person's funding source(s) and real account(s) without divulging the payer-selected funding source(s) and payer-selected real account(s) of the payer to the payee's depository bank or financial institution and/or to the payee(s). As a further example, a payer could hire an auto-pay type computer-implemented service company in order to use that company's server to automatically communicate with and instruct the payment broker's server on the payer's behalf to instruct the server(s) of payer-selected funding source(s) to cause payment(s) to be made to payee(s) as described herein from the payer's funding source(s) and real account(s) without divulging the payer-selected funding source(s) and payer-selected real account(s) of the payer to the payee's depository bank or financial institution and/or to the payee(s) in order for the payer to pay various periodic or non-periodic bills or debts of the payer. Further, each of the payer's authorized agents or users may also be registered with the payment broker to use one or more electronic devices that are also registered with the payment broker's server for such purposes. Still further, the payer may instruct the payment broker's server to place limits or restrictions on the payer's authorized agents or users permitted communications and payment instructions to the payment broker's server, such as per-payment amount limits or restrictions limiting the authorized agent or user to only being able to communicate with and instruct the payment broker's server to instruct the server(s) of payer-selected funding source(s) to cause payments to be made to payee(s) as described herein only from payer-selected real account(s) to only certain payer-designated payee(s), without divulging the payer-selected funding source(s) and payer-selected real account(s) of the payer to the payee's depository bank or financial institution and/or to the payee(s).

As discussed previously in regard to purchaser charge backs and merchant returns in merchant/purchaser payment transactions supported by the systems and methods described herein, similar functionality and methods can be used to support other underlying payment transactions that the payer and payee may also wish to implement such as money transfers, bill payments, utilities payments, the payment of wages or any other forms of payment or remittance of funds or transfers of value, and also depending in part upon the laws, regulations and rules applicable to the subject underlying transaction(s) involved. With regard to the systems and methods described herein, the payer (and in most cases, the payee) may have relationships with the payment broker that are consistent and comply with all applicable laws, regulations and rules. This applies to merchant/purchaser and other payment transactions where the payer and payee may need to have relationships with the payment broker that (i) are consistent and in compliance with the laws, regulations and rules governing the implemented payment transaction(s), such as charge-backs and merchant returns in merchant/purchaser transactions or applicable requirements in money transfer transactions, and (ii) authorize the payment broker's server to instruct the server(s) of payer-selected funding source(s) to cause the reversal of the entire prior payment transactions as described herein in a manner that is consistent with those laws, regulations and rules.

It will be seen that implementations of the systems and methods described herein may not require that the payer or payee have an electronic device to communicate with the payment broker. Any means whether now known or developed in the future by which the payer or payee can communicate with the payment broker will suffice, including by using text messaging or any analog or digital electronic device and related telecommunications network or system, a touch-tone or rotary telephone and the conventional telephone system or by visiting or speaking with a customer-service representative of the payment broker who gathers the necessary information and payer's instruction and inputs it into the payment broker's server and orally communicates back the necessary payment transaction information to the payer and/or payee.

Authorization requests and payment instructions can be initiated and instructed solely by the payer and the payer can use the payment broker's server to seek authorizations from and instruct the servers of a multitude of different types of payer-selected funding sources with regard to various payer real accounts. The payment broker's server can act solely at the payer's instruction in obtaining authorization from the server of the payer-selected funding source and instructing the funding source server to cause the payer's payment to be made to a payee as described herein from the payer-selected funding source and payer-selected real account(s) of the payer without divulging the payer-selected funding source and payer-selected real account(s) of the payer to the payee's depository bank or financial institution and/or to the payee. The payer can also instruct the payment broker's server as to which depository institution(s) and real account(s) of the payee the payer wants the desired payment to be caused to be made, as described herein, in each case without divulging the payer-selected funding source(s) and payer-selected real account(s) of the payer to the payee's depository bank or financial institution and/or to the payee, with the payer and not the payee making the selection, providing the instructions and controlling the payment process. Thus, implementations of the systems and methods in accordance herewith can be entirely “payer-controlled” and can support virtually all payment transaction types (e.g., credit card, debit card, checking account, deposit account, loyalty account, value account, etc.) and all payment purposes (point of sale purchases, money transfers, bill payment, payment of wages, utility payments, donations, contributions or any other payments or remittances of funds or transfers of value, etc.) As previously indicated, the payer may designate one or more agents or users to act for and as authorized by the payer in communicating with and instructing the payment broker's server in order to instruct server(s) of the payer-selected funding source(s) to cause payment(s) to be made to payee(s) as described herein on the payer's behalf without divulging the payer-selected funding source(s) and payer-selected real account(s) of the payer to the payee's depository bank or financial institution and/or to the payee(s). The payer may select a single funding source or multiple funding sources and a single real account or multiple real accounts for the desired payment (i.e., may instruct the payment broker's server to implement a split payment) or the payer may instruct the payment broker's server to instruct the server(s) of the payer-selected funding source(s) to cause payments to be made to payees as described herein from certain preferred funding source(s) or real account(s) generally or only with respect to specific payees without divulging the payer-selected funding source(s) and payer-selected real account(s) of the payer to the payee's depository bank or financial institution and/or to the payee.

Implementations of the systems and methods described herein can also eliminate much of the risk for the payee. In addition, since the payer initiates and controls the authorization and payment process, the risk of fraud from a third party accessing the payer's real account(s) is much reduced, particularly since real account identifying information is not stored, transmitted or received by the payer's or payee's electronic devices. Further, in one implementation, the payment broker's server calls on one or more secure databases for information relating to the payer or payee and processing options. The secure database information may be stored in the payment broker's secure site or elsewhere, or it may be stored in one or more secure databases at one or more funding sources. The payment broker's server requests or instructs the server of the payer-selected funding source to authorize, or cause the payment to be made to the payee as further described herein, and the funding source server receives, associates, obtains or selects all information necessary to authorize, or cause the payment to be made to the payee as further described herein. In addition, if the payment broker is also acting as a funding source and hosting one or more real account(s) of the payer, then for a given payment, the functions performed by the payment broker's server and the server of the funding source may be combined into a single server implementation without a separate server for the funding source function.

In some embodiments, the payment broker's server has completed the required processing, gained authorization approval from the server of the payer-selected funding source, and instructed the funding source server to cause the payment to be made to the payee as described herein without divulging the payer-selected funding source and payer-selected real account(s) of the payer to the payee's depository bank or financial institution and/or to the payee, and would then provide completion information for routing back to the payer and/or payee. In one embodiment, the authorization and payment can be caused to occur in real-time since once authorization has been obtained from the server of the payer-selected funding source, the payment can be caused to be made to the payee as described herein pursuant to the payer's instructions. In this embodiment, the server of the payer-selected funding source is provided with concurrent instructions to the effect that if authorization is approved, the payment is to be caused to be made to the payee as described herein (e.g., if-then type instructions) without divulging the payer-selected funding source and payer-selected real account(s) of the payer to the payee's depository bank or financial institution and/or to the payee.

In other embodiments, such as those involving a typical credit or debit card authorization request, pursuant to the payer's instruction, the payment broker's server calls upon one or more secure database(s) owned or controlled by the payment broker or one or more secure databases owned or controlled by a funding source to obtain all necessary data and information and continue with an authorization request to the server of the payer-selected funding source (e.g., a credit issuing institution); gains authorization approval from the funding source server, and then transmits an authorization approval notification to the payer's and/or payee's electronic device with the related instruction to the funding source server to cause the payment to be made to the payee on a periodic or batch settlement basis, without divulging the payer-selected funding source and payer-selected real account(s) of the payer to the payee's depository bank or financial institution and/or to the payee.

The approval or denial of the authorization request can be sent by the payment broker's server without the payment broker's server divulging the payer-selected funding source(s) and payer-selected real account(s) of the payer to the payee's depository bank or financial institution and/or to the payee.

Since typically there is very little information (for security and privacy concerns) stored on the payer's or payee's electronic device, the payment broker's server or the server of the payer-selected funding source can each call on the applicable secure database(s) to supply necessary data and information in order to complete most authorization or payment transactions, including causing a payment to be made to the payee as described herein. It is preferred that no funding source, depository institution, real account, account type or related identifier data be stored on any payer or payee electronic device that is part of an implementation in accordance herewith. In one implementation, the payer's electronic device secure software application does not permanently store any payment transaction data on the device but only sends such data to the payment broker's server for processing.

The systems and methods described herein may or may not use existing Visa, MasterCard, Discover, American Express, or other conventional credit or debit networks typically used by a payee (e.g., a merchant) for authorization, instruction, clearing or settlement purposes. If the payer elects to pay with a credit or debit card real account designated to the payment broker's server at a given payer-selected funding source, pursuant to the payer's instruction, the payment broker's server may route the authorization request to the appropriate card network that will route the request to the server of the payer-selected funding source to process and respond to the authorization request and/or related payment instructions to cause a payment to be made to the payee as described herein, without divulging the payer-selected funding source(s) and payer-selected real account(s) of the payer to the payee's depository bank or financial institution and/or to the payee. If the payer elects to pay using a transfer of funds from a debit card real account at a payer-selected funding source to a payer-selected or approved real account of the payee at a depository institution, then other known existing networks may be used by the server of the payer-selected funding source to cause the payment transaction to be made to the payee as described herein as instructed by the payer, without divulging the payer-selected funding source and payer-selected real account(s) of the payer to the payee's depository bank or financial institution and/or to the payee.

When the payment broker's server instructs the server of a payer-selected funding source to cause a payment to be made in regard to a payer-selected real account at the payer-selected funding source to the payee as instructed by the payment broker's server on the payer's behalf and at the payer's instruction as described herein, the payment may be caused to be made to the payee as described herein in any manner now known or developed in the future that can result in the payment being caused to be made into the payer-selected or approved real account of the payee, in each case without divulging the payer-selected funding source and payer-selected real account(s) of the payer to the payee's depository bank or financial institution and/or to the payee.

In particular, these non-divulging methods, each of which can prevent chain-of-transaction details from accompanying the payment to the payee and thereby prevent the divulgation of the payer's sensitive funding source and real account information to the payee's depository bank or financial institution and/or to the payee, can include, without limitation, (i) in a preferred embodiment, having the payment broker's server instruct the server of the payer-selected funding source to itself instruct the server of a bank or financial institution with which the funding source has a relationship, such as a bank or financial institution that hosts one or more payment and/or clearing account(s) of the funding source or a bank or financial institution that hosts one or more payment and/or clearing account(s) of the bank or financial institution on behalf and for the benefits of the funding source, to make the payment to the payer-selected or approved real account of the payee from such payment and/or clearing account(s), (ii) having the payment broker's server instruct the server of the payer-selected funding source to itself instruct the server of a subsidiary or affiliate of the funding source (which subsidiary or affiliate is itself a bank or financial institution) to make the payment to the payer-selected or approved real account of the payee from a real account(s) of such subsidiary or affiliate at such subsidiary or affiliate, (iii) having the payment broker's server instruct the server of the payer-selected funding source to itself instruct the electronic device of a subsidiary or affiliate of the funding source (which subsidiary or affiliate is not a bank or financial institution) to instruct the server of a bank or financial institution associated with such subsidiary or affiliate to make the payment from a real account(s) of such subsidiary or affiliate at such bank or financial institution to the payer-selected or approved real account of the payee, or (iv) having the payment broker's server instruct the server of the payer-selected funding source to itself instruct the electronic device of a third party with which the funding source has an appropriate contractual or other relationship to instruct the server of a bank or other financial institution associated with the third party to make the payment from a real account(s) of the third party at such bank or financial institution to the payer-selected or approved real account(s) of the payee, in each of the foregoing cases so as to not divulge the payer-selected funding source and payer-selected real account(s) of the payer to the payee's depository bank or financial institution and/or to the payee. In addition, those of ordinary skill in the art of payments will recognize that many combinations and permutations of the above methods are feasible and within the spirit and scope of the invention and can result in payment(s) being caused to be made to payee(s) without divulging the payer-selected funding source(s) and payer-selected real account(s) of the payer to the payee's depository bank or financial institution and/or to the payee.

Further, concurrently with the server of the payer-selected funding source causing the payment to be made to a payee as described herein at the instruction of the payment broker's server on the payer's behalf in accordance with the payer's instruction as described herein, or after or before the payment is so caused to be made, the payer-selected funding source can use funds from the payer-selected real account(s) of the payer to (i) reimburse the bank or financial institution, subsidiary, affiliate or third party that made or instructed its bank or financial institution make the payment to the payee as described herein, as applicable, for the amount of the payment, (ii) pre-fund the amount of the payment to the bank or financial institution, subsidiary, affiliate or third party that will make or instruct its bank or financial institution to make the payment to the payee as described herein, as applicable, or (iii) reimburse the funding source, when the funding source has offset the amount of the payment from obligations otherwise owed to the funding source by the bank or financial institution, subsidiary, affiliate or third party that made or instruct its bank or financial institution make the payment to the payee as described herein, as applicable, in each case so as to not divulge the payer-selected funding source and payer-selected real account(s) of the payer to the payee's depository bank or financial institution and/or to the payee. Of course, the manner in which authorization is obtained from the server of a given payer-selected funding source or a payment is caused to be made to a payee as described herein, in each case with the payer-selected funding source(s) and payer-selected real account(s) of the payer not being divulged to the payee's depository bank or financial institution and/or to the payee, can be determined by the payment broker's server in accordance with the payer's instruction such that each and all of those activities will comply with all applicable laws, including all financial reporting, anti-money laundering and anti-terrorism laws.

In addition, in a preferred embodiment the manner in which authorization is obtained from the server of a payer-selected funding source or a payment is caused to be made to a payee as described herein at the instruction of the payment broker's server in accordance with the payer's instruction as described herein can each also be determined with a view to reducing or eliminating unnecessary fees or charges that might otherwise be incurred by the payer-selected funding source or by the bank or financial institution, subsidiary, affiliate or third party or their respective banks or financial institutions making the payment as described herein, as applicable, or in connection with the alternative methods of causing the payment to be made to the payee as described herein, provided that in each case that the payer-selected funding source(s) and payer-selected real account(s) of the payer are not divulged to the payee's depository bank or financial institution and/or to the payee.

Any type of electronic communication among payers or payees with the payment broker's server(s) or with the server(s) of payer-selected funding source(s) (and vice versa) or with the server(s) of payee depository bank(s) or financial institution(s) or among any or all of the forgoing servers can be utilized. Furthermore, as described above, the various computational entities (i.e., electronic devices) that participate in a transaction can communicate over the same or different modalities. Intercommunicating computational entities can include the server of the funding source's bank or financial institution, the server of a subsidiary or affiliate of the funding source (which may or may not be a bank or financial institution), or the server of a third party, etc., in order to route authorization requests or instructions so as obtain authorization for a payment or cause a payment to be made to a payee as described herein, or to receive authorization approvals, denials or confirmations of remittance or transfer, or to transmit or receive any other instructions, communications, confirmations or completion information as described herein. Further, as instructed by the payment broker's server for or on behalf of the payer and at the payer's instruction, the server of the payer-selected funding source may also use any suitable type of electronic communication to exchange data with the payer and/or payee in order to electronically communicate authorization approval notifications, denials or completion confirmations of payments, remittances or transfers, etc. In a preferred embodiment, any and all communications by any or all of the servers, electronic devices, entities or persons described above or herein are made electronically via secure sessions for additional security and privacy. It will also be seen that the systems and methods described herein can be used globally wherever the necessary telecommunications, computer networks and payment routing and/or clearing infrastructures are available.

In a preferred embodiment of the systems and methods described herein, the payment broker's server, as well as the payer's electronic device and related payment broker provided secure software application operating in a payer mode of operation or the payee's electronic device as well as the related payment broker provided secure software application operating in a payee mode of operation can each be configured and implemented to incorporate and use state of the art user validation, privacy and compliance functionality such as multi-factor authentication, strong cryptography, geolocation, PKI, encrypted database(s), digital ink and digital signature functionality, as well as dynamic (e.g., real-time) audit functionality for fraud or irregularity detection, and instant application locking if fraud or an irregularity is detected or other validation, authentication, privacy, compliance, fraud or irregularity detection technologies that may be developed in the future.

Indeed, in a preferred implementation, the payment broker's server can be organized and configured to provide the functionality and implement the methods described herein via a single backend push-pull engine and secure database(s) configuration structure. Such a configuration can allow the addition of new functionality and features on-the-fly. In addition, any payer entitlements or benefits (such as coupons, special offers or other add-value features, etc.) that may be offered to a payer by the payment broker or its alliance members or commercial partners (including possibly merchants or funding sources) can be managed dynamically and driven by a master payer profile, thereby facilitating the addition of new entitlements or benefits on-the-fly with all related data and content pulled and processed by the payment broker's server on the payer's behalf in real-time. This configuration or other configurations that may be developed in the future can allow for single-point testing, certification and upgrading as well as flexibility in adding new functionality, features, entitlements and benefits. Further, alliance or commercial partner entitlements, benefits and data can be added or removed conveniently via direct feeds, the use of application programmer interfaces or similar interface methods.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1-6. (canceled)

7. A telecommunication system comprising:
a) an electronic communication device connected to and configured for communication over a telecommunication network, the electronic device comprising:
a device communication facility permitting communication over the telecommunication network via a secure session; and
a processor configured for running a secure application for (i) authenticating or obtaining authentication information from a payer, (ii) communicating via secure sessions and accessing secure databases, (iii) receiving payee identifying real account and depository bank or financial institution information, (iv) receiving a selection by the payer of a funding source and at least one real account or account type associated with the payer, and (v) receiving a selection by the payer of at least one real account and depository bank or financial institution associated with the payee;
b) a brokerage server, operated by a payment broker and connected to and configured for communication over the telecommunication network, the brokerage server comprising:
a server communication facility permitting communication over the telecommunication network via a secure session;
a computer memory comprising a secure database; and
a processor configured for (i) receiving authentication information via the telecommunication network using the server communication facility, (ii) authenticating and identifying the payer based on the authentication information, (iii) receiving, via the telecommunication network using the server communication facility, an instruction from the payer instructing that a payment be made electronically from the payer-selected funding source and at least one payer-selected real account or account type thereof to a payer-selected real account and depository bank or financial institution, other than the payment broker, associated with the payee, the selection of the real account and depository bank or financial institution associated with the payee being controlled by the payer and not by the payee, (iv) computationally retrieving, from the secure database, information identifying the payer-selected funding source and the at least one payer-selected real account or account type thereof and the payee and the payer-selected real account of the payee at a depository bank or financial institution other than the payment broker, (v) requesting, via the telecommunication network using the server communication facility, the server of the payer-selected funding source to authorize the payment to the payee, (vi) if the payment is authorized by the server of the payer-selected funding source, instructing such server, via the telecommunication network using the server communication facility, to cause the payment to be made electronically to the payee on the funding source's behalf by a third party other than the payment broker such that the identities of the payer-selected funding source and the at least one payer-selected real account of the payer at the funding source are not divulged to the payee and such funding source and real-account identifying information is not transmitted to, received or stored by the payee's depository bank or other financial institution, and (vii) instructing the server of the payer-selected funding source, via the telecommunication network using the server communication facility, to reimburse or transfer the amount of the payment to the third party from the at least one payer-selected real account of the payer at the funding source; and
c) a funding source server, operated by a payer-selected funding source and connected to and configured for communication over the telecommunication network, the funding source server comprising:
a server communication facility permitting communication over the telecommunication network via a secure session;
a computer memory comprising a secure database; and
a processor configured for (i) receiving, via the telecommunication network using the server communication facility, the request from the payment broker server for authorization of the payment, (ii) computationally retrieving, from a secure database, information identifying the payer and the at least one payer-selected real account of the payer at the funding source, (iii) authorizing or denying the requested payment, (iv) in response to instruction from the payment broker server following authorization, instructing, via the telecommunication network using the server communication facility, the electronic device of at least one third party other than the payment broker to instruct over a telecommunications facility via a secure session the server of a bank or financial institution associated with the third party to make the payment electronically to the payee from a real account of the third party at such bank or financial institution and in the third party's name and not in the name of the payment broker, the funding source or the payer, thereby preventing divulgation, both to the payee's depository bank or financial institution and the payee, of the identity of the payment broker or funding source and the at least one payer-selected real account of the payer at the funding source, and (v) reimbursing or transferring the amount of the payment to the third party from the at least one payer-selected real account of the payer at the funding source,
Wherein the server of the depository bank or financial institution associated with the payee does not receive chain-of-transaction details containing the payer's funding source or real account information.

8. The telecommunication system of claim 7, wherein the server of the depository bank or financial institution associated with the payee does not receive details identifying the payment broker.

9. The telecommunication system of claim 7, wherein the brokerage server communicates with the payer via a secure session over the telecommunication network to and from a hand-held payer electronic device.

10. The telecommunication system of claim 7, wherein the brokerage server communicates with the payee via a secure session over the telecommunication network to and from a payee electronic device.

11. The telecommunication system of claim 7, wherein the electronic communication device and brokerage server are configured to transmit and receive only an account type and not information identifying a real account of the payer.

12. The telecommunication system of claim 11, wherein, in response to an authorization request by the brokerage server, the funding source server is configured to query a secure database of the funding source in order to associate the payer account type with a corresponding real account of the payer and respond to the authorization request.
